(19) United States
(12) Patent Application Publication
(10) Pub. No.: US 2016/0032150 A1
(43) Pub. Date: Feb. 4, 2016

(54) EBC-CROSSLINKED ADHESIVE TAPE FOR SHEATHING ELONGATED GOODS

(71) Applicant: tesa SE, Hamburg (DE)

(72) Inventors: Fabian GÜNZLER, Offenburg (DE); Michael SIEBERT, Schenefeld (DE); Dennis SEITZER, Reutlingen (DE); Christof HÖLGER, Weil am Rhein (DE)

(73) Assignee: tesa SE, Hamburg (DE)

(21) Appl. No.: 14/882,806

(22) Filed: Oct. 14, 2015

Related U.S. Application Data
(62) Division of application No. 13/960,418, filed on Aug. 6, 2013.

(30) Foreign Application Priority Data
Aug. 7, 2012 (EP) 12 179 471.3

(51) Int. Cl. C09J 7/04; H01B 13/08

(52) U.S. Cl. CPC C09J 7/045; H01B 13/08; C09J 2433/00; C09J 2400/263; C09J 2201/122; C09J 2201/606

(57) ABSTRACT

Method for wrapping cables which are exposed to elevated temperatures and/or humidity, with an adhesive tape comprising a carrier and a pressure-sensitive adhesive composition which is applied to at least one side of the carrier and is in the form of a dried and electron beam (EBC)-crosslinked polymeric acrylate dispersion which is built up from a) monomeric acrylates and optionally b) ethylenically unsaturated comonomers which are not acrylates, wherein the pressure-sensitive adhesive composition comprises between 15 and 100 parts by weight of a tackifier (based on the weight of the dried polymeric dispersion).

This is a Division of U.S. application Ser. No. 13/960,418 filed Aug. 6, 2013, now pending, claiming priority of European Application 12 179 471.3 filed Aug. 7, 2012, the disclosure of which is incorporated herein by reference

The invention relates to an adhesive tape for sheathing elongated goods, such as, in particular, cable looms in automobiles, its production and the use for sheathing cables.

### BACKGROUND OF THE INVENTION

Adhesive tapes have been used for a long time in industry for the production of cable harnesses. In this context the adhesive tapes serve to bundle a large number of electrical leads before installation or in the already assembled state, in order to reduce the space requirement of the lead bundle by taping and additionally to achieve protective functions.

The testing and classification of adhesive tapes for cable sheathing is carried out in the automobile industry in accordance with comprehensive standards, such as, for example, LV 312-1 “Protection systems for wiring harnesses in motor vehicles, adhesive tapes; test guideline” (October 2009) as a joint standard of the companies Daimler, Audi, BMW and Volkswagen or the Ford specification ES-XU5T-1A303-aa (Revision September 2009) “Harness Tape Performance Specification”. Hereinafter these standards are abbreviated to LV 312 or Ford specification.

Cable-wrapping tapes having film and textile carriers, which as a rule are coated on one side with various pressure-sensitive adhesive compositions, are widely used. These cable-wrapping tapes must meet five main requirements.
a. Easy to unwind:
   The product presented in roll form must be easy to unwind for easy processing.
b. —Flagging.
   Flagging is understood—for an adhesive tape wrapped around a body—as the tendency of an end of adhesive tape to protrude. The cause results from the combination of holding force due to the adhesive, the rigidity of the carrier and the diameter of the cable loom. Very high requirements regarding a balanced ratio of cohesion and adhesion are imposed on the sticking/taping, which under no circumstances should become detached, since in practice ends of adhesive tape should not become detached by themselves.
c. Cable compatibility:
   The cable insulation must not become brittle due to the influence of the adhesive tape in combination with elevated temperature over a relatively long period of time. A distinction is made here according to LV 312 between four temperature classes T1 to T4, corresponding to 80° C. (also called temperature class A), 105° C. (also called temperature class B (105)), 125° C. (also called temperature class C) and 150° C. (also called temperature class D), which the wrapped cables must withstand for 3,000 h without becoming brittle. It goes without saying that the temperature classes T3 and T4 impose higher demands on the adhesive tape than the lower classes T1 and T2. Both the cable insulation material and the pressure-sensitive adhesive composition and carrier type are decided via the classification T1 to T4.
d. Compatibility with chemicals and compatibility with media in the engine compartment
e. Mechanical stability
   There are uneven, non-uniform substrates in the automobile due to the cable strands, corrugated tubes and branchings. To these are also added flexural and tensile stress during production, installation and later use in the engine compartment of an automobile or also in the vehicle body with constant flexural stress when opening doors.

Since in the ideal case the end of the adhesive tape is stuck to its own reverse side, a good immediate adhesive strength (tack) on this substrate must be present, so that flagging of the adhesive tape does not occur at the start. In order to ensure a flagging-free product in the long term, the anchoring to the substrate and the inner strength of the adhesive composition must be so pronounced that the adhesive bond lasts even under the influence of stress (tensile and flexural stress).

Flagging—in the case of an adhesive tape wound around a body—is understood as the tendency of an end of the adhesive tape to protrude. The cause results from the combination of holding force due to the adhesive, the rigidity of the carrier and the diameter of the cable loom.

In practice, the ends of the adhesive tape should not become detached by themselves.

The flagging resistance of Wire Harnessing (WH) cable-wrapping tapes is determined via the TFT method (threshold flagging time). In this context a limit value of 2,000 min TFT is defined as the target parameter for an absolutely flagging-free woven product.

Cable-wrapping tapes with pressure-sensitive adhesive compositions based on natural rubber usually show a good flagging resistance, but have an unrolling force which increases over the storage time and at increasing temperatures. Furthermore they comply with only the lower temperature classes for cable compatibility. According to DE 198 46 901 A1, natural rubber compositions are irradiated through the carrier side of the adhesive tape. UV-crosslinkable cable-wrapping tapes with pressure-sensitive adhesive compositions based on polyacrylic acid esters comply with the high temperature classes, but tend towards flagging. EP 2 298 845 A1 reduces the tendency towards flagging by reduction of the flexural strength in the warp direction. EP 1 431 360 A2 discloses adhesive tapes which can be wrapped on themselves and have a thermally bonded nonwoven having a weight per unit area of from 10 to 50 g/m² and UV-crosslinked acrylate adhesive. Woven adhesive tapes which are based on an acrylate hot melt composition and are classified according to LV 312 into temperature class D (150° C.) are also known. These have a low anchoring of the composition and in the case of smooth carrier surfaces lead to adhesive transfer, as Comparative Example 4 shows. Furthermore, acrylate hot melt adhesive compositions can be blended in order to incorporate resins or fillers only under difficult conditions.

Further woven tapes have the same adhesive composition, which can be adjusted to the later use by the amount of composition applied and UV crosslinking. A disadvantage of this standard range is that on critical wrappings, such as branchings, transitions, small diameters, they have tape ends which protrude noticeably in the wrapping. It is also a disadvantage that they must be irradiated at least with a UV dose of 20 mJ/cm³ to generate wrappable products, but the adhesion optimum is obtained at a UV dose of 10 mJ/cm³. In return, however, the products then show too high a side edge tackiness on the roll below a UV dose of 20 mJ/cm³. These rolls must therefore be separated from one another by intermediate layers on packing. A further disadvantage is that there is only a narrow process window in which the flagging properties and the flow, due to the low crosslinking, are sufficient, which, however, due to the low crosslinking with relatively short polymer chains of low molecular weight, leads to cohesive fractures. An additional crosslinking is therefore necessary in order to ensure adequate cohesion. If stresses occur, such as tensile or flexural load, the adhesive composition breaks easily and the ends of the tape lift up.

The present invention is based on the object of providing an adhesive tape which, in spite of being easy to unwind, has a good flagging resistance and a good immediate adhesive strength. Furthermore, the adhesives tapes should be easily adjustable to individual requirements, such as particular temperature circumstances, high humidity and/or particular mechanical stresses, such as narrow radii or else constant bending. The adhesive tape should render possible a particularly simple, inexpensive and rapid sheathing of elongated goods, such as cable looms in automobiles. Preferably, a good cable compatibility over all the temperature classes mentioned is aimed for.

This object is achieved by an adhesive tape such as is defined in the main claim. In this context, the sub-claims provide advantageous further developments of the adhesive tape and methods for the use of the adhesive tape.

### SUMMARY

The invention provides an adhesive tape, in particular for wrapping cables, comprising a preferably textile carrier and a pressure-sensitive adhesive composition which is applied to at least one side of the carrier and is in the form of a dried and electron beam (EBC)-crosslinked polymeric acrylate dispersion, in particular an aqueous acrylate dispersion, preferably having a gel value of greater than 40%, determined by means of Soxhlet extraction, wherein the polymeric acrylate dispersion comprises polymers which are built up from

a) monomeric acrylates and optionally
b) ethylenically unsaturated comonomers which are not acrylates, wherein the pressure-sensitive adhesive composition comprises between 15 and 100 parts by weight of a tackifier (based on the weight of the dried polymeric dispersion).

The acrylate dispersion employed according to the invention in the pressure-sensitive adhesive composition comprises polymers which are built up from monomeric acrylates and optionally ethylenically unsaturated comonomers which are not acrylates, wherein the dried and non-EBC-crosslinked acrylate dispersion preferably has a gel value of greater than 40%. In the present context, monomeric acrylates are understood as meaning those acrylates in which the acrylate has a carbonyl group (C═O), such as, preferably, all monomeric acrylates having an optionally functionalized parent structure C═C—(C═O)—, so that acrylamides are counted among the acrylates and acrylonitriles are counted among the ethylenically unsaturated comonomers.

Preferably, the pressure-sensitive adhesive composition comprises an acrylate dispersion, preferably an aqueous acrylate dispersion, which comprises polymers which are built up from

a) greater than 40 wt. % of monomeric acrylates and
b) 0 to 60 wt. % of ethylenically unsaturated comonomers,
wherein the monomeric acrylates include mono-, di- and/or polyfunctional acrylates and wherein the ethylenically unsaturated comonomers are chosen from ethylene-containing monomers, vinyl-functional monomers and unsaturated hydrocarbons having 3 to 8 C atoms, based on the polymers (expressed as 100 wt. %) in the acrylate dispersion.

### DETAILED DESCRIPTION

In contrast to the acrylate hot melt and solvent-based acrylates, the acrylate dispersions, in particular aqueous acrylate dispersions, are distinguished in that a separation of the polymer balls originating from the individual dispersion beads is still present in them to a certain degree (see inter alia BASF-Handbuch Lackiertechnik, Artur Goldschmidt, Hans-Joachim Streitberger, 2002, chap. 3.1.2.1, FIG. 3.1.5, p. 337 et seq.).

The molecular weight of acrylate dispersions cannot be appropriately determined because of the high gel content. The high gel content results from the chain transfer reactions in the dispersion particles. In emulsion polymerization in particular, the probability of such a crosslinking is high, since only growing polymer chains and monomers are to be found in the dispersion particles, so that this crosslinking is increased greatly compared with solvent polymerization. The peculiarity of acrylate dispersions, in particular of aqueous acrylate dispersions, is that due to this type of crosslinking in the demarcated space of the dispersion particles branched molecules of high molecular weight are formed. The high gel value of acrylate dispersions also readily explains the situation that they can often be employed as pressure-sensitive adhesive compositions without further crosslinking. This is in contrast to the acrylate hot melt or solvent-based acrylate adhesive compositions, which as a general rule have to be post-crosslinked. Typical acrylate hot melt compositions have a low gel value of 10%.

On the other hand, the polymeric acrylate dispersions used in the pressure-sensitive adhesive compositions according to the invention, in particular dried, originally aqueous acrylate dispersions, have a gel value of greater than 40%, which can be determined by means of Soxhlet extraction. Typical acrylate dispersions such as can be employed according to the invention are described in DE 10 2011 075 156 A1, DE 10 2011 075159 A1, DE 10 2011 075 152 A1 and DE 10 2011 075 160 A1, which have been filed at the German Patents and Trademarks Office and to which reference is made in their entirety with respect to the acrylate dispersions which can be employed according to the invention. These acrylate dispersions are explained in more detail below.

A particular advantage of the resin-blended acrylate dispersions according to the invention lies in the simple and economical individual possibility of matching the acrylate dispersions to the particular requirements and the desired carrier material. A second advantage lies in the fact that an optionally desired crosslinking of the resin-modified acrylate dispersions after drying in the coating process can easily be carried out from the composition side by means of EBC, in order to establish the optimum of cohesion and adhesion (see FIG. 10). An essential advantage which manifests itself in the properties of the acrylate dispersions is that the acrylate dispersions—in contrast to hot melt and solvent-based adhesive compositions—to a certain degree maintain a separation of the polymer balls originating from the individual dispersion beads.

Due to the EBC irradiation, a wide-mesh crosslinking is formed within the polymer balls and leads to an increase in the molecular weight in the polymer balls. Advantageously, virtually no crosslinking takes place between the polymer balls, so that the composition remains readily flowable and renders possible a good wetting of the adherend base. This phenomenon can be proved by means of rheological investigations (such as DMA, dynamic mechanical analysis) which are represented in FIG. 11. Thus, the frequency sweep at RT (25° C.) shown in FIG. 11 shows that the viscosity properties at different shear rates of the non-EBC-crosslinked and the EBC-crosslinked samples is virtually identical. The composition which was irradiated with an EBC power of 50 kGy shows no change in the tan delta at 0.1 rad/s compared with the non-irradiated sample. At 100 rad/s a slight increase in the tan delta is found. The combination of the tan delta value at low angular frequencies (0.1 rad/s) and the complex viscosity gives indications of the static shear strength. Falling tan delta values with a simultaneously high complex viscosity tend to mean an increasing shear strength. At tan delta values of less than 0.2, the tendency towards adhesive fracture predominates. Generally, tan delta falls with increasing crosslinking and/or molecular weight—FIG. 12. The high angular frequencies of 100 rad/s or higher reflect the tack property of a pressure-sensitive adhesive composition. In this context, increasing tan delta values at low complex viscosities represent increasing tack.

The temperature sweep in the range of from −40° C. to 130° C. shown in FIG. 13 gives a virtually identical glass transition temperature (T_{g}) for the non-EBC-crosslinked and the EBC-crosslinked sample. The increase in the molecular weight within the polymer ball has the effect of a certain increase in the cohesion of the adhesive composition and leads to tougher detachment properties when stresses occur, as shown in FIG. 10. Adhesive tapes having a readily tolerable side edge tackiness even with low to no EBC crosslinking are obtained by the process according to the invention.

The acrylate dispersions employed according to the invention offer particular advantages by the very simple blendability with predispersed resins, auxiliary substances, fillers, anti-ageing agents, etc. It is even possible to adjust the pressure-sensitive adhesive compositions to be employed according to the invention comprising acrylate dispersions such that they already give an adequate cohesion without additional crosslinking (EBC crosslinking) and therefore, with slightly increased unwinding forces, can be employed on finished rolls of adhesive tape. The EBC crosslinking is therefore a process factor of only limited critical nature.

In general, the pressure-sensitive adhesive compositions to be employed according to the invention which are based on acrylate dispersions show a very wide process window with respect to the crosslinking, the TFT time levelling out at a certain level (see FIG. 8) as the EBC dose increases, and at the same time the adhesive strengths decreasing only very slowly and stabilizing at a level with good adhesive strengths. An EBC crosslinking to be described as “over-crosslinking” in the test series carried out, which are not reproduced in their entirety in the examples, was not to be observed.

The invention provides an adhesive tape according to the features mentioned, of which the TFT value (threshold flagging time) after the electron beam crosslinking (EBC) is preferably greater than 1,000 minutes, in particular greater than 1,500, preferably greater than 1,700, particularly preferably greater than 2,000 minutes, preferably greater than 2,500 minutes. An essential advantage of the pressure-sensitive adhesive compositions employed according to the invention comprising acrylate dispersions manifests itself in the low suitable electron beam doses of particularly preferably greater than 5 kGy to 10 kGy, in particular 10 to 20, 20 to 30, 30 to 40, alternatively particularly preferably from 35 to 45, or also greater than 40 to at most 50 kGy, expediently up to 80 kGy, which are sufficient, in particular that as the EBC dose from the composition side, to achieve, depending on the carrier material used and the particular pressure-sensitive adhesive composition, TFT values of greater than 1,500 minutes, preferably of greater than 2,000 minutes, preferably greater than 2,100, particularly preferably greater than 2,200, preferably TFT values of greater than 2,500 or even greater than 3,000 and greater than 4,000 minutes.

Adhesive tapes according to the invention show no flagging properties according to the measurement method LV 312 (measurement is carried out with 19-mm-wide adhesive tape strips, glass as the substrate, after storage for 24 hours): The protruding tape end has at most a length of less than 2 mm, preferably less than 1 mm to absolutely no flagging, in each case with a range of variation of plus/minus 0.5 mm, preferably of plus/minus 0.2 mm.

The invention also provides an adhesive tape having a pressure-sensitive adhesive composition which is applied to one side of the carrier and the weight per unit area of which is less than 120 g/m², in particular less than 100 g/m², preferably less than 90 g/m², particularly preferably less than 80 g/m², preferably less than 70 g/m², and in alternatives also equal to 60 g/m² and less than 50 g/m², in each case having a range of variation of plus/minus 2 g/m², preferably plus/minus 1 g/m², wherein preferably TFT values of 1,000 minutes can already be achieved with the non-EBC-crosslinked pressure-sensitive adhesive compositions.

Adhesive tapes according to the invention are advantageously distinguished in that the TFT value (threshold flagging time) after the electron beam crosslinking is greater by about the factor 2 than the TFT value before the electron beam crosslinking (EBC). Preferably, low EBC doses of less than 40 kGy, in particular less than 35 kGy, particularly preferably less than 30 kGy, preferably of less than 20 kGy, down to less than 10 kGy, are already sufficient for this.

The invention furthermore also provides adhesive tapes having a pressure-sensitive adhesive composition applied to one side of the carrier and a carrier which is impregnated with an additional acrylate dispersion, wherein this acrylate dispersion is not counted in the weight per unit area of the pressure-sensitive adhesive composition. The impregnation can be applied with a weight per unit area of less than 30 g/m², in particular less than 25 g/m², preferably less than 20 g/m², particularly preferably less than 10 g/m², with a range of variation of plus/minus 5 g/m². The acrylate dispersions used for the impregnation are distinguished in that in the dried state they preferably have only very low or no pressure-sensitive adhesive properties. Acrylate dispersions or optionally also polyurethane, rubber-based or SBR impregnations which in the dried state preferably have only very low or no pressure-sensitive adhesive properties can therefore be employed. Blocking of the layers on the bundles is prevented in this manner. Acrylate dispersions according to the invention having low or no pressure-sensitive adhesive properties, i.e. without resins, can optionally be employed.

With the pressure-sensitive adhesive compositions comprising acrylate dispersions EBC-crosslinked according to the invention very good flagging-free products having a low application of acrylate dispersions per unit area can be obtained even with carrier materials of which the weight per unit area is varied over wide ranges, which vary from 30 to 250 g/m², preferably from 50 to 200 g/m², particularly preferably from 60 to 150 g/m², and/or of which the flexural strength varies in the range of from 0 to 30 mN/60 mm as the untreated carrier (MD, machine direction), optionally from 2 to 30 mN/60 mm as the untreated carrier (MD) and therefore also of which the flexural strength differs widely.

The invention also provides adhesive tapes having a flexural strength of the adhesive tape (MD) having EBC-crosslinked pressure-sensitive adhesive compositions having values of from 0 to 30 mN/60 mm, alternatively from 4 to 30 mN/60 mm, preferably from 6 mN/60 mm to 25 mN/60 mm. The flexural strength of the carrier can be influenced as a function of the amount of composition applied and the penetration properties of the composition into the carrier. Generally, the lowest possible flexural strength is aimed for.

Adhesive tapes having a combination of weight per unit area of the textile carrier, in particular nonwoven carrier, of from 30 to 250 g/m², preferably from 60 to 150 g/m², having a weight per unit area of the pressure-sensitive adhesive composition of from 20 to 150 g/m², preferably from 50 to 150 g/m², comprising 15 to 50 parts by weight of a resin, preferably 30 to 50 parts by weight of resin, such as, preferably, a rosin ester resin, optionally having an impregnation with an acrylate dispersion having a weight per unit area of up to 30 g/m², are likewise preferred. The carrier is particularly preferably a PET woven fabric.

A particular advantage of the adhesive tapes according to the invention lies in that the viscosity of the pressure-sensitive adhesive composition remains essentially unchanged by the electron beam crosslinking (EBC) or the electron beam crosslinking of polymers essentially takes place within the polymer balls, the molecular weight of the polymers in the polymer balls increasing compared with the non-irradiated polymer balls, and in particular the electron beam crosslinking of the polymers between the polymer balls is lower, preferably negligible, compared with the electron beam crosslinking within the polymer balls. This can be seen from the DMA values according to FIG. 11 with the aid of the viscosity courses of EBC-crosslinked and non-crosslinked samples which were evaluated over a particular frequency range of from 0.1 to 100 rad/s (recorded from 0.1 to far above 100 rad/s), which shows the influence of the EBC crosslinking on the viscosity of the pressure-sensitive adhesive composition with and without EBC crosslinking. FIG. 11 thus shows impressively that the viscosity essentially does not change due to the EBC crosslinking. Likewise, this can be shown with the aid of the gel values before and after the EBC crosslinking, both of which lie in the range of from 40 to 60%, preferably between 42 to 55% or between 44 to 50%, where the measurement accuracy can be plus/minus 3%.

According to preferred embodiments, the adhesive tape, in particular for wrapping cables, comprises a carrier and a pressure-sensitive adhesive composition which is applied to at least one side of the carrier and is in the form of a dried and electron beam-crosslinked acrylate dispersion, which in particular is EBC-crosslinked from the composition side, wherein the acrylate dispersion, in particular the non-dried acrylate dispersion, comprises polymers which are built up or obtainable from (i) a) monomeric acrylates chosen from 0 to 90 wt. % of n-butyl acrylate, 2-ethylhexyl acrylate, 2-ethylhexyl acrylate and ethyl acrylate and 0 to 2 wt. % of a di- or polyfunctional monomer, particularly preferably to the extent of 0 to 1 wt. % of a di- or polyfunctional monomer, b) ethylenically unsaturated comonomers to the extent of 10 to 60 wt. % chosen from at least one ethylenically unsaturated monofunctional monomer or a mixture of these and 0 to 10 wt. % of an ethylenically unsaturated monomer having an acid or acid anhydride function, or

(ii) a) monomeric acrylates chosen from 90 to 99 wt. % of n-butyl acrylate and/or 2-ethylhexyl acrylate and 0 to 2 wt. % of a di- or polyfunctional monomer, particularly preferably to the extent of 0 to 1 wt. % of a di- or polyfunctional monomer, b) ethylenically unsaturated comonomers to the extent of 10 to 1 wt. % chosen from at least one ethylenically unsaturated monofunctional monomer or a mixture of these and 0 to 10 wt. % of an ethylenically unsaturated monomer having an acid or acid anhydride function, or
(iii) a) monomeric acrylates chosen from 30 to 69 wt. %, preferably 40 to 60 wt. % of alkyl acrylate esters having C₄- to C₁₂-alkyl radicals, b) ethylenically unsaturated comonomers to the extent of 5 to 25 wt. %, preferably 10 to 22 wt. % of ethylene, 20 to 55 wt. %, preferably 28 to 38 wt. % of vinyl acetate and 0 to 10 wt. % of other ethylenically unsaturated compounds; wherein the acrylate dispersion is prepared by reacting the monomers according to i, ii and/or iii in an emulsion polymerization, in each case based on the polymers (expressed as 100 wt. %) in the acrylate dispersion. In this context it is particularly preferable if the pressure-sensitive adhesive composition comprises between 30 and 50 parts by weight of a tackifier (based on the weight of the dried polymeric dispersion), particularly preferably rosin ester resin.

According to further preferred embodiments, the adhesive tape, in particular for wrapping cables, comprises a carrier and a pressure-sensitive adhesive composition which is applied to at least one side of the carrier and is in the form of a dried and electron beam-crosslinked acrylate dispersion, wherein the acrylate dispersion, in particular the non-dried acrylate dispersion, comprises polymers which are built up or obtainable from a) monomeric acrylates which are chosen from alkyl (meth)acrylates, preferably C₁- to C₂₀-alkyl (meth)acrylates, C₁- to C₁₀-hydroxyalkyl (meth)acrylates, such as, in particular, hydroxyethyl or hydroxypropyl (meth)acrylate, acid amides, such as acrylamide or methacrylamide, and mixtures of two or more of the monomers, from b) monomeric comonomers which are chosen from ethylene, aromatic vinyl monomers, such as styrene, α-methylstyrene and vinyltoluene, divinylbenzene, vinyl esters of carboxylic acids comprising up to 20 carbon atoms, such as vinyl laurate, vinyl ethers of alcohols comprising up to 10 carbon atoms, such as vinyl methyl ether or vinyl isobutyl ether, vinyl halides, such as vinyl chloride or vinylidene dichloride, itaconic acid, maleic acid, fumaric acid and/or maleic anhydride, acrylonitrile and/or methacrylonitrile, unsaturated hydrocarbons having 3 to 8 carbon atoms, such as propene, butadiene, isoprene, 1-hexene or 1-octene, and mixtures of two or more comonomers.

According to further preferred embodiments, the adhesive tape, in particular for wrapping cables, comprises a carrier and a pressure-sensitive adhesive composition which is applied to at least one side of the carrier and is in the form of a dried and electron beam-crosslinked acrylate dispersion, wherein the acrylate dispersion comprises polymers which are built up or obtainable from a) monomeric acrylates which are chosen from acrylic acid or methacrylic acid, n-butyl acrylate, ethyl acrylate such as 2-ethylhexyl acrylate, 2-ethylhexyl acrylate and mixtures of two or more monomers which are built up or obtainable from a) di- or polyfunctional monomers which are chosen from alkyl diacrylates, such as 1,2-ethylene glycol diacrylate, 1,4-butanediol diacrylate, 1,6-hexanediol diacrylate, 1,8-octanediol diacrylate or 1,12-dodecanediol diacrylate, and triacrylates, such as trimethylolpropane triacrylate, and tetraacrylates, such as pentaerythritol tetraacrylate, and optionally in combination with the monomeric comonomers mentioned under b).

The invention accordingly relates to an adhesive tape, in particular for wrapping cables, comprising a preferably textile carrier and a pressure-sensitive adhesive composition which is applied to at least one side of the carrier and is in the form of a dried polymer dispersion, wherein the polymer is built up from:

(a.1) 40 to 90 wt. % of n-butyl acrylate and/or 2-ethylhexyl acrylate
(a.2) 60 to 10 wt. % of one or more ethylenically unsaturated monofunctional acrylate monomers which differ from (a.1) and
(a.3) 0 to 1 wt. % of a di- or polyfunctional acrylate monomer,
(b) 0 to 10 wt. % of an ethylenically unsaturated monomer having an acid or acid anhydride function, which is not an acrylate, and/or (a.4) 0 to 5 wt. % of an ethylenically unsaturated acrylate monomer having an acid or acid anhydride function
and the pressure-sensitive adhesive composition comprises between 15 and 100 parts by weight of a tackifier (based on the weight of the dried polymer dispersion).

The adhesive composition is a pressure-sensitive adhesive composition, that is to say an adhesive composition which already allows a permanent bond with almost all adherend bases under a relatively weak pressing-on pressure and after use can be detached again from the adherend base essentially without residue. A pressure-sensitive adhesive composition has a permanent pressure-sensitive adhesive action at room temperature, that is to say has a sufficiently low viscosity and a high touch tackiness such that it already wets the surface of the particular adherend base under a low pressing-on pressure. The adherability of the adhesive composition is based on its adhesive properties and the re-detachability is based on its cohesive properties.

Ethyl acrylate is preferred as monomer (a.2) or at least a part of the monomers (a.3). 2-Ethylhexyl acrylate is preferred as monomer (a.1). According to a further preferred embodiment, the monomer (a) comprises 2-ethylhexyl acrylate and simultaneously the monomer (a.2) or at least a part of the monomers (a.3) comprises ethyl acrylate. Very particularly preferably, the polymer is built up from (a.1) 40 to 60 wt. % of 2-ethylhexyl acrylate, (a.2) 60 to 40 wt. % of ethyl acrylate, (a.3) 0 to 0.5 wt. % of a di- or polyfunctional monomer, (b) 0 to 5 wt. % of an ethylenically unsaturated monomer having an acid or acid anhydride function and/or (a.4) 0 to 5 wt. % of an ethylenically unsaturated acrylate monomer having an acid or acid anhydride function.

Advantageously, for example, itaconic acid, maleic acid, fumaric acid and/or maleic anhydride are possible as monomer (b) and/or 0 to 5 wt. % of an ethylenically unsaturated acrylate monomer having an acid or acid anhydride function, such as, preferably, acrylic acid, methacrylic acid, is possible as monomer (a.4). Acrylic acid or methacrylic acid, optionally the mixture of the two, are preferred.

Monomers (a.2) include alkyl (meth)acrylates, preferably Cᵣ to C₂₀-alkyl (meth)acrylates, C₁- to C₁₀-hydroxyalkyl (meth)acrylates, such as, in particular, hydroxyethyl or hydroxypropyl (meth)acrylate, acid amides, such as acrylamide or methacrylamide, with the exception of the monomers forming (b), aromatic vinyl monomers, such as styrene, α-methylstyrene and vinyltoluene, vinyl esters of carboxylic acids comprising up to 20 carbon atoms, such as vinyl acetate or vinyl laurate, vinyl ethers of alcohols comprising up to 10 carbon atoms, such as vinyl methyl ether or vinyl isobutyl ether, vinyl halides, such as vinyl chloride or vinylidene dichloride, and unsaturated hydrocarbons having 2 to 8 carbon atoms, such as ethylene, propene, butadiene, isoprene, 1-hexene or 1-octene. Ethyl acrylate is particularly preferred according to the invention.

Examples of polyfunctional ethylenically unsaturated monomers (b) are divinylbenzene, and as (a.4) alkyl diacrylates, such as 1,2-ethylene glycol diacrylate, 1,4-butanediol diacrylate, 1,6-hexanediol diacrylate, 1,8-octanediol diacrylate or 1,12-dodecanediol diacrylate, triacrylates, such as trimethylolpropane triacrylate, and tetraacrylates, such as pentaerythritol tetraacrylate.

The polymer dispersion is prepared by the process of emulsion polymerization of the components mentioned. Descriptions of this process are given, for example, in “Emulsion Polymerization and Emulsion Polymers” by Peter A. Lovell and Mohamed S. El-Aasser-Wiley-VCH 1997-ISBN 0-471-96746-7 or in EP 1 378 527 B1.

Typical acrylate dispersions such as can be employed according to the invention are described in DE 10 2011 075 156 A1, DE 10 2011 075159 A1, DE 10 2011 075 152 A1 and DE 10 2011 075 160 A1 and explained in more detail below.

The pressure-sensitive adhesive composition preferably comprises an aqueous acrylate dispersion, that is to say a polyacrylic acid ester which is finely dispersed in water and has pressure-sensitive adhesive properties, such as are described, for example, in the Handbook of Pressure Sensitive Technology by D. Satas.

Acrylate pressure-sensitive adhesive compositions are typically copolymers, polymerized by means of free radicals, of acrylic acid alkyl esters or methacrylic acid alkyl esters of C₁- to C₂₀-alcohols, such as, for example, monomers a) methyl acrylate, ethyl (meth)acrylate, n-butyl (meth)acrylate, t-butyl (meth)acrylate, cyclohexyl (meth)acrylate, 2-ethylhexyl (meth)acrylate, n-octyl (meth)acrylate, iso-octyl (meth)acrylate, n-decyl (meth)acrylate, n-dodecyl (meth)acrylate, tetradecyl (meth)acrylate, lauryl (meth)acrylate, oleyl (meth)acrylate, palmityl (meth)acrylate and stearyl (meth)acrylate, in addition to further (meth)acrylic acid esters, such as isobornyl (meth)acrylate, benzyl (meth)acrylate, phenyl (meth)acrylate and 2-bromoethyl (meth)acrylate, alkoxyalkyl (meth)acrylates, such as ethoxyethyl (meth)acrylate, or also acid amides, such as acrylamide or methacrylamide.

The comonomers for the preparation of the acrylate dispersions furthermore include b) esters of ethylenically unsaturated di- and tricarboxylic acids and anhydrides, such as ethyl maleate, dimethyl fumarate and ethyl methyl itaconate, and also vinylaromatic monomers, such as, for example, styrene, vinyltoluene, methylstyrene, n-butylstyrene, decylstyrene among these. For influencing the physical and optical properties of the pressure-sensitive adhesive composition, polyfunctional ethylenically unsaturated monomers b) are possible as crosslinker monomers, for example divinylbenzene.

Further possible monomers (b) for achieving the advantageous properties are vinyl esters of carboxylic acids comprising up to 20 carbon atoms, such as vinyl acetate or vinyl laurate, vinyl ethers of alcohols comprising up to 10 carbon atoms, such as vinyl methyl ether or vinyl isobutyl ether, vinyl halides, such as vinyl chloride or vinylidene dichloride, nitriles, such as acrylonitrile or methacrylonitrile, and unsaturated hydrocarbons having 2 to 8 carbon atoms, such as ethylene, propene, butadiene, isoprene, 1-hexene or 1-octene.

For influencing the physical and optical properties of the pressure-sensitive adhesive composition, polyfunctional ethylenically unsaturated acrylate monomers (a.4) are possible in a) as crosslinker monomers. Examples of these are alkyl diacrylates, such as 1,2-ethylene glycol diacrylate, 1,4-butanediol diacrylate, 1,6-hexanediol diacrylate, 1,8-octanediol diacrylate or 1,12-dodecanediol diacrylate, triacrylates, such as trimethylolpropane triacrylate, and tetraacrylates, such as pentaerythritol tetraacrylate. The group of these polyfunctional monomers also includes UV-crosslinkable monomers, such as, for example, (meth)acrylate-functionalized derivatives of benzophenone or of benzoin.

A further group of a) acrylate monomers are those which generate a latent crosslinking potential in the polymer and, after drying of the adhesive composition, lead spontaneously (often under catalysis) to a network structure. Such a monomer is, for example, glycidyl methacrylate, the oxirane ring of which leads, with hydroxyl or, in particular, carboxylate functions, to a covalent bond by ring opening. This reaction takes place in an accelerated manner in the presence of zinc ions or, in particular, in the presence of carboxyl functions and/or amines.

To achieve pressure-sensitive adhesive properties, the processing temperature of the adhesive composition must be above its glass transition temperature, so that it has viscoelastic properties.

Typical particle sizes of the dispersed polymer according to the invention extend from 20 nm up to 10 μm. The polymer dispersion is prepared by the process of emulsion polymerization of acrylate monomers and possibly further ethylenically unsaturated monomers. Descriptions of this process are given, for example, in “Emulsion Polymerization and Emulsion Polymers”—Peter A. Lovell and Mohamed S. El-Aasser-Wiley-VCH 1997-ISBN 0-471-96746-7 or in EP 1 378 527 B1.

The shear viscosities of commercial dispersions as a rule lie below those of the process according to the invention. To achieve the necessary shear viscosities, as a rule rheology additives, also called thickeners, are employed.

A distinction is made in principle here between organic and inorganic rheology additives.

The organic thickeners in turn are divided into two essential action principles: (i) thickening of the aqueous phase, that is to say non-associating, and (ii) associate formation between the thickener molecule and particles, sometimes with inclusion of stabilizers (emulsifiers). Representatives of the first (i) substance group are water-soluble polyacrylic acids and polycoacrylic acids, which form polyelectrolytes of high hydrodynamic volume in a basic medium. The person skilled in the art also calls these ASEs (alkali swellable emulsions) for short. They are distinguished by high shear viscosities at rest and high shear dilution. Another substance class are the modified polysaccharides, in particular cellulose ethers, such as carboxymethylcellulose, 2-hydroxyethylcellulose, carboxymethyl-2-hydroxyethylcellulose, methylcellulose, 2-hydroxyethylmethylcellulose, 2-hydroxyethylethylcellulose, 2-hydroxypropylcellulose, 2-hydroxypropylmethylcellulose, 2-hydroxybutylmethylcellulose. This substance class additionally includes less widely used polysaccharides, such as starch derivatives and specific polyethers.

The active group of (ii) associative thickeners are in principle block copolymers having a water-soluble central block and hydrophobic end blocks, the end blocks interacting with the particles or themselves and thereby forming a three-dimensional network including the particles. Typical representatives are familiar to the person skilled in the art as HASE (hydrophobically modified alkali swellable emulsion), HEUR (hydrophobically modified ethylene oxide urethane) or HMHEC (hydrophobically modified hydroxyethylcellulose). In HASE thickeners, the central block is an ASE, and the end blocks are usually long, hydrophobic alkyl chains coupled on via polyethylene oxide bridges. In the HEUR the water-soluble central block is a polyurethane, in HMHEC a 2-hydroxyethylcellulose. The nonionic HEUR and HMHEC in particular are largely insensitive to pH.

Depending on the structure, the associative thickeners more or less cause Newtonian (independent of shear rate) or pseudoplastic (shear-liquefying) flow properties. They occasionally also show a thixotropic character, that is to say in addition to a shear force dependency of the viscosity, they also show a time dependency.

The inorganic thickeners are usually laminar silicates of natural or synthetic origin, examples are hectorites and smectites. In contact with water, the individual layers detach themselves from one another. Due to different charges on the surfaces and edges of the platelets, they form a space-filling house of cards structure at rest, from which high shear viscosities at rest up to flow limits result. Under shear, the house of cards structure collapses and a clear drop in the shear viscosity is to be observed. The build-up of the structure can take some time, depending on the charge, concentration and geometric dimensions of the platelets, so that thixotropy can also be achieved with such inorganic thickeners.

The thickeners can in some cases be stirred directly into the adhesive dispersion, or in some cases they are advantageously prediluted or predispersed in water beforehand. Typical use concentrations are 0.1 to 5 wt. %, based on the solids.

Suppliers of thickeners are, for example, OMG Borchers, Omya, Byk Chemie, Dow Chemical Company, Evonik, Rockwood or Münzing Chemie.

According to a further embodiment, the polymeric acrylate dispersions can comprise polymers which are built up from:

(a.1) 40 to 90 wt. % of n-butyl acrylate and/or 2-ethylhexyl acrylate
(b) 0 to 10 wt. % of an ethylenically unsaturated monomer having an acid or acid anhydride function
(a.2) 60 to 10 wt. % of one or more ethylenically unsaturated monofunctional acrylate monomers which differ from (a.1)
(a.3) 0 to 1 wt. % of a di- or polyfunctional acrylate monomer and/or
as (a.4) 0 to 5 wt. % of an ethylenically unsaturated acrylate monomer having an acid or acid anhydride function, and the pressure-sensitive adhesive composition comprises between 15 and 100 parts by weight of a tackifier (based on the weight of the dried polymer dispersion).

Preferably, ethyl acrylate forms the monomer (a.2) or at least a part of the monomers (a.2). Preferably, 2-ethylhexyl acrylate forms the monomer (a.1). According to a further preferred embodiment, the monomer (a) comprises 2-ethylhexyl acrylate and simultaneously the monomer (a.2) or at least a part of the monomers (a.2) comprises ethyl acrylate.

Very particularly preferably, the polymer is built up from

(a.1) 40 to 60 wt. % of 2-ethylhexyl acrylate
(b) 0 to 5 wt. % of an ethylenically unsaturated monomer, in particular (b.1) 0 to 5 wt. % of an ethylenically unsaturated monomer having an acid or acid anhydride function or instead of (b) as (a.4) 0 to 5 wt. % of an ethylenically unsaturated acrylate monomer having an acid or acid anhydride function
(a.2) 60 to 40 wt. % of ethyl acrylate or instead of (a.2) a (b.2) ethylenically unsaturated monomer which is not an acrylate
(a.3) 0 to 0.5 wt. % of a di- or polyfunctional monomer.

As monomer (b.2) are preferably chosen aromatic vinyl monomers, such as styrene, α-methylstyrene and vinyltoluene, vinyl esters of carboxylic acids comprising up to 20 carbon atoms, such as vinyl acetate or vinyl laurate, vinyl ethers of alcohols comprising up to 10 carbon atoms, such as vinyl methyl ether or vinyl isobutyl ether, vinyl halides, such as vinyl chloride or vinylidene dichloride, and unsaturated hydrocarbons having 2 to 8 carbon atoms, such as ethylene, propene, butadiene, isoprene, 1-hexene or 1-octene.

Advantageously, for example, divinylbenzene, itaconic acid, maleic acid, fumaric acid and/or maleic anhydride are possible as monomer (b.1). Advantageously, for example, acrylic acid, methacrylic acid are possible as monomer (a.4). Acrylic acid or methacrylic acid, optionally the mixture of the two, are preferred.

Monomers (a.2) include alkyl (meth)acrylates, preferably C₁- to C₂₀-alkyl (meth)acrylates, C₁- to C₁₀-hydroxyalkyl (meth)acrylates, such as, in particular, hydroxyethyl or hydroxypropyl (meth)acrylate, acid amides, such as acrylamide or methacrylamide, with the exception of the monomers forming (b), aromatic vinyl monomers, such as styrene, α-methylstyrene and vinyltoluene, vinyl esters of carboxylic acids comprising up to 20 carbon atoms, such as vinyl acetate or vinyl laurate, vinyl ethers of alcohols comprising up to 10 carbon atoms, such as vinyl methyl ether or vinyl isobutyl ether, vinyl halides, such as vinyl chloride or vinylidene dichloride, and unsaturated hydrocarbons having 2 to 8 carbon atoms, such as ethylene, propene, butadiene, isoprene, 1-hexene or 1-octene. Ethyl acrylate is particularly preferred according to the invention.

Examples of polyfunctional ethylenically unsaturated monomers (a.3) are alkyl diacrylates, such as 1,2-ethylene glycol diacrylate, 1,4-butanediol diacrylate, 1,6-hexanediol diacrylate, 1,8-octanediol diacrylate or 1,12-dodecanediol diacrylate, triacrylates, such as trimethylolpropane triacrylate, and tetraacrylates, such as pentaerythritol tetraacrylate.

To achieve pressure-sensitive adhesive properties, the adhesive composition must be above its glass transition temperature at the processing temperature, in order to have viscoelastic properties. Since the cable loom wrapping is carried out at normal ambient temperature (approximately between 15° C. to 25° C.), the glass transition temperature of the pressure-sensitive adhesive composition formulation (polymer-tackifier mixture) is preferably below +15° C. (determined with DSC (differential scanning calorimetry) in accordance with DIN 53 765 at a heating-up rate of 10 K/min).

A further particularly preferred embodiment of the invention thus comprises a mixture of 2-ethylhexyl acrylate as monomer (a) and ethyl acrylate as monomer (a.2) and terpene phenols and/or rosin esters having a softening point above 90° C. according to ASTM E28-99 (2009).

Particularly preferred compositions comprise, for example: polymer 1: 50 wt. % of 2-ethylhexyl acrylate, 2 wt. % of acrylic acid, 48 wt. % of ethyl acrylate; polymer 2: 81 wt. % of 2-ethylhexyl acrylate, 1 wt. % of acrylic acid, 18 wt. % of methyl acrylate; polymer 3: 84 wt. % of butyl acrylate, 1 wt. % of acrylic acid, 8 wt. % of methyl acrylate; 7 wt. % of vinyl acrylate. The pressure-sensitive adhesive compositions mentioned were formulated from polymer 1 by blending with adhesive resin dispersions. In this context, the number indicates the parts by weight of tackifier, based on 100 parts by weight of polymer 1 (in each case based on solids). Composition formulations by way of example from polymer 1 are prepared: B1 with 45 parts of rosin ester resin Snowtack 100G, Lawter, B2 with 40 parts of rosin resin ester Snowtack 780 G, Lawter, B3 with 35 parts of terpene phenol resin Dermulsene TR 602, DRT, B4 from polymer 2 and B5 from polymer 3, in each case blended with 40 parts by weight of the rosin ester resin Snowtack 100G having a softening point of 99° C.

According to a further embodiment, the polymeric acrylate dispersion comprises polymers from: (a.1) 90 to 99 wt. % of n-butyl acrylate and/or 2-ethylhexyl acrylate,

(b) 0 to 10 wt. % of an ethylenically unsaturated monomer, in particular 0 to 10 wt. % of an ethylenically unsaturated monomer having an acid or acid anhydride function, or instead of (b) as (a.4) 0 to 5 wt. % of an ethylenically unsaturated acrylate monomer having an acid or acid anhydride function,
(a.2) 10 to 1 wt. % of one or more ethylenically unsaturated monofunctional acrylate monomers which differ from (a.1) or instead of (a.2) a (b.2) ethylenically unsaturated monomer which is not an acrylate,
(a.3) 0 to 1 wt. % of a di- or polyfunctional acrylate monomer, and the pressure-sensitive adhesive composition comprises between 15 and 100 parts by weight of a tackifier (based on the weight of the dried polymer dispersion).

Preferably, 10 to 1 wt. % of acrylonitrile and/or methacrylonitrile form the monomer (b.2) or at least a part of the monomers (b.2), particularly preferably acrylonitrile. Preferably, 2-ethylhexyl acrylate forms monomer (a.1).

According to a further preferred embodiment, the monomer (a.1) comprises 2-ethylhexyl acrylate and simultaneously the monomer (b.2) or at least a part of the monomers (b.2) comprises acrylonitrile and/or methacrylonitrile, preferably acrylonitrile.

A particularly preferred embodiment of the invention thus comprises a mixture of 2-ethylhexyl acrylate as monomer (a) and acrylonitrile as monomer (b.2).

Advantageously, for example, acrylic acid, methacrylic acid are possible as monomer (a.4). Acrylic acid or methacrylic acid, optionally the mixture of the two, are preferred. Advantageously, for example, itaconic acid, maleic acid, fumaric acid and/or maleic anhydride are alternatively possible as monomer (b).

Monomers (a.2) include alkyl (meth)acrylates, preferably C₁- to C₂₀-alkyl (meth)acrylates, with the exception of the monomers forming (a.1), C₁- to C₁₀-hydroxyalkyl (meth)acrylates, such as, in particular, hydroxyethyl or hydroxypropyl (meth)acrylate, acid amides, such as acrylamide or methacrylamide. Acrylonitrile is particularly preferred according to the invention.

Monomers (b.2) furthermore include aromatic vinyl monomers, such as styrene, α-methylstyrene and vinyltoluene, vinyl esters of carboxylic acids comprising up to 20 carbon atoms, such as vinyl acetate or vinyl laurate, vinyl ethers of alcohols comprising up to 10 carbon atoms, such as vinyl methyl ether or vinyl isobutyl ether, vinyl halides, such as vinyl chloride or vinylidene dichloride, and unsaturated hydrocarbons having 2 to 8 carbon atoms, such as ethylene, propene, butadiene, isoprene, 1-hexene or 1-octene, acrylonitrile and methacrylonitrile.

Examples of polyfunctional ethylenically unsaturated monomers (a.3) are alkyl diacrylates, such as 1,2-ethylene glycol diacrylate, 1,4-butanediol diacrylate, 1,6-hexanediol diacrylate, 1,8-octanediol diacrylate or 1,12-dodecanediol diacrylate, triacrylates, such as trimethylolpropane triacrylate, and tetraacrylates, such as pentaerythritol tetraacrylate. Alternatively as (b) 0 to 1 wt. % of divinylbenzene.

Compositions of the polymer dispersions by way of example are: polymer 1: 93 wt. % of 2-ethylhexyl acrylate, 4 wt. % of acrylic acid, 3 wt. % of acrylonitrile; polymer 2: 92 wt. % of 2-ethylhexyl acrylate, 2 wt. % of acrylic acid, 6 wt. % of methyl methacrylate; polymer 3: 95 wt. % of butyl acrylate, 1 wt. % of acrylic acid, 4 wt. % of vinyl acetate. The pressure-sensitive adhesive compositions listed in Table 1 were formulated from polymer 1 by blending with adhesive resin dispersions. B1 with 45 parts of rosin ester resin Snowtack 100G, Lawter; B2 with 40 parts of rosin ester resin Snowtack 780 G, Lawter, B3 with 35 parts of terpene phenol resin. Polymers 2 and 3, in each case blended with 40 parts by weight of the rosin ester resin Snowtack 100G having a softening point of 99° C., serve as Examples B4 and B5.

According to a further embodiment, the acrylate dispersions comprise polymers from:

(b.1) 5 to 25 wt. %, preferably 10 to 22 wt. % of ethylene
(a.1) 30 to 69 wt. %, preferably 40 to 60 wt. % of alkyl acrylate ester having C₄- to C₁₂-alkyl radicals
(b.3) 20 to 55 wt. %, preferably 28 to 38 wt. % of vinyl acetate
(a.2) 0 to 10 wt. % of other ethylenically unsaturated compounds or instead of (a.2) a (b.2) ethylenically unsaturated monomer which is not an acrylate,
and the pressure-sensitive adhesive composition comprises between 15 and 100 parts by weight of a tackifier (based on the weight of the dried polymer dispersion).

The monomer (a.1) is preferably n-butyl acrylate and/or 2-ethylhexyl acrylate.

Monomers (a.2) include alkyl (meth)acrylates, preferably C₁- to C₂₀-alkyl (meth)acrylates, C₁- to C₁₀-hydroxyalkyl (meth)acrylates, such as, in particular, hydroxyethyl or hydroxypropyl (meth)acrylate, acid amides, such as acrylamide and/or methacrylamide.

Monomers (b.2) include monomers forming (b), such as aromatic vinyl monomers, such as divinylbenzene, styrene, α-methylstyrene and vinyltoluene, vinyl esters of carboxylic acids comprising up to 20 carbon atoms, such as vinyl laurate, vinyl ethers of alcohols comprising up to 10 carbon atoms, such as vinyl methyl ether or vinyl isobutyl ether, vinyl halides, such as vinyl chloride or vinylidene dichloride, and unsaturated hydrocarbons having 3 to 8 carbon atoms, such as propene, butadiene, isoprene, 1-hexene or 1-octene or mixtures thereof. Divinylbenzene can be added to the extent of 0 to 1 wt. %.

Furthermore, a di- or polyfunctional monomer can advantageously be added to the polymer as monomer (a.3), and indeed preferably to the extent of 0 to 2 wt. % and particularly preferably to the extent of 0 to 1 wt. %. Examples of polyfunctional ethylenically unsaturated acrylate monomers are alkyl diacrylates, such as 1,2-ethylene glycol diacrylate, 1,4-butanediol diacrylate, 1,6-hexanediol diacrylate, 1,8-octanediol diacrylate or 1,12-dodecanediol diacrylate, triacrylates, such as trimethylolpropane triacrylate, and tetraacrylates, such as pentaerythritol tetraacrylate.

The polymer dispersion is prepared by the process of emulsion polymerization of the components mentioned. Particularly preferred embodiments and detailed descriptions of the starting substances and of the preparation processes are to be found in EP 0 017 986 B1 and EP 0 185 356 B1.

Composition of a further example of a polymer dispersion: The example of a polymer dispersion was prepared in accordance with Example 1 of EP 0 017 986 B1 and accordingly comprised 46.7 wt. % of 2-ethylhexyl acrylate, 31.1 wt. % of vinyl acetate, 18 wt. % of ethylene, 2.6 wt. % of acrylamide and 1.6 wt. % of acrylic acid. Pressure-sensitive adhesive compositions were formulated from this polymer dispersion. B1 with 45 parts of rosin ester resin Snowtack 100G, Lawter, B2 with 40 parts of rosin ester resin Snowtack 780 G, Lawter, B3 with 35 parts of terpene phenol resin Dermulsene TR 602, DRT.

To achieve pressure-sensitive adhesive properties, the pressure-sensitive adhesive composition must be above its glass transition temperature at the processing temperature, in order to have viscoelastic properties. Since the cable loom wrapping is carried out at normal ambient temperature (approximately between 15° C. to 25° C.), the glass transition temperature of the pressure-sensitive adhesive composition (acrylate dispersion with tackifier mixture) is preferably below +15° C. (determined with DSC (differential scanning calorimetry) in accordance with DIN 53 765 at a heating-up rate of 10 K/min).

The glass transition temperature of the acrylate copolymers can be estimated in accordance with the equation of Fox from the glass transition temperatures of the homopolymers and their relative ratios of amounts (cf. T. G. Fox, Bull. Am. Phys. Soc. 1 (1956) 123). Due to the tackifier the glass transition temperature necessarily increases by approx. 5 to 40 K, depending on the amount added, compatibility and softening temperature. Accordingly, only acrylate copolymers having a glass transition temperature of at most 0° C. are suitable.

When wrapping a cable loom, the adhesive tape is stuck on from not overlapping at all to completely overlapping around the cable, which as a rule has a small radius, so that the adhesive tape is curved to a very high degree. At the end of a wrapped section, the tape is conventionally wrapped predominantly on to its own reverse side, so that the degree of overlapping is virtually complete, similarly to the conventional presentation form as a roll of adhesive tape, where the pressure-sensitive adhesive composition is likewise stuck to its own reverse side. In the case of flagging, static forces act, such as, for example, due to the flexural strength of the carrier and the wrapping tension, which can lead to the open ends of the adhesive tape standing up in an undesirable manner, similarly to the start of unwinding by itself. The flagging resistance is thus the ability of the pressure-sensitive adhesive composition to withstand this static force. The acrylate dispersion by itself does not meet the requirements of an adhesive tape for wrapping cables. In particular, the required flagging resistance is not sufficient.

The use of tackifiers for increasing the adhesive strengths of pressure-sensitive adhesive compositions is known in principle. The tackifiers added therefore also contribute to a certain extent to the improved flagging resistance. Greater than 15 to 100 parts by weight of tackifier (based on the weight of the dried polymeric dispersion), usually 20 to 80 parts by weight, further preferably 30 to 50 parts by weight are added to the pressure-sensitive adhesive composition according to the invention.

Surprisingly and unforeseeably to the person skilled in the art, the use of adhesive resins in the adhesive tape according to the invention does not simultaneously lead to a difficult unwinding, although both requirements have the common feature that the pressure-sensitive adhesive composition has contact with its own reverse side.

All known substance classes are in principle suitable as tackifiers, also called adhesive resins. Tackifiers are, for example, hydrocarbon resins (for example polymers based on unsaturated C₅- or C₉-monomers), terpene phenol resins, polyterpene resins based on raw materials such as, for example, α- or β-pinene, aromatic resins, such as coumarone-indene resins, or resins based on styrene or α-methylstyrene, such as rosin and its secondary products, for example disproportionated, dimerized or esterified rosin, for example reaction products with glycol, glycerol or pentaerythritol, to name only some. Preferred resins are those without readily oxidizable double bonds, such as terpene phenol resins, aromatic resins and particularly preferably resins which are prepared by hydrogenation, such as, for example, hydrogenated aromatic resins, hydrogenated polycyclopentadiene resins, hydrogenated rosin derivatives or hydrogenated polyterpene resins.

Preferred resins are those based on terpene phenols and rosin esters. Adhesive resins having a softening point above 80° C. according to ASTM E28-99 (2009) are likewise preferred. Particularly preferred resins are those based on terpene phenols and rosin esters having a softening point above 90° C. according to ASTM E28-99 (2009). The resins are expediently employed in dispersion form. In this way they can be mixed in finely divided form with the polymer dispersion without problems. Rosin ester resins are particularly preferably added as tackifiers.

A particularly preferred embodiment of the invention thus comprises a pressure-sensitive adhesive composition comprising an acrylate dispersion of 2-ethylhexyl acrylate (monomer a.1) and ethyl acrylate (monomer a.2) and terpene phenols and/or rosin esters having a softening point above 90° C. according to ASTM E28-99 (2009).

To improve the cable compatibility further, the adhesive composition formulation can optionally be blended with light stabilizers or primary and/or secondary anti-ageing agents. Products based on sterically hindered phenols, phosphites, thio synergists, sterically hindered amines or UV absorbers can be employed as anti-ageing agents. Primary antioxidants, such as, for example, Irganox 1010 or Irganox 254, by themselves or in combination with secondary antioxidants, such as, for example, Irgafos TNPP or Irgafos 168, are preferably employed. The anti-ageing agents can be used in this context in any desired combination with one another, mixtures of primary and secondary antioxidants in combination with light stabilizers, such as, for example, Tinuvin 213, showing a particularly good anti-ageing action.

Anti-ageing agents in which a primary antioxidant is combined with a secondary antioxidant in one molecule have proved to be very particularly advantageous. These anti-ageing agents are cresol derivatives, the aromatic ring of which is substituted by thioalkyl chains on two different sites as desired, preferably in the ortho and meta position relative to the OH group, it also being possible for the sulphur atom to be bonded to the aromatic ring of the cresol unit via one or more alkyl chains. The number of carbon atoms between the aromatic and the sulphur atom can be between 1 and 10, preferably between 1 and 4. The number of carbon atoms of the alkyl side chain can be between 1 and 25, preferably between 6 and 16. Compounds of the type 4,6-bis(dodecylthiomethyl)-o-cresol, 4,6-bis(undecylthiomethyl)-o-cresol, 4,6-bis(decylthiomethyl)-o-cresol, 4,6-bis(nonylthiomethyl)-o-cresol or 4,6-bis(octylthiomethyl)-o-cresol are particularly preferred here. Such anti-ageing agents are available, for example, from the company Ciba Geigy under the name Irganox 1726 or Irganox 1520.

The amount of anti-ageing agent or anti-ageing agent package added should lie in a range of between 0.1 and 10 wt. %, preferably in a range of between 0.2 and 5 wt. %, particularly preferably in a range of between 0.5 and 3 wt. %, based on the total solids content.

The presentation form in the form of a dispersion for particularly easy miscibility with the adhesive composition dispersion is preferred. Alternatively, liquid anti-ageing agents can also be incorporated directly into the dispersion, in which case a standing time of some hours should also follow the incorporation step, in order to render possible homogeneous distribution in the dispersion or absorption of the anti-ageing agent into the dispersion particles. A further alternative is the addition of an organic solution of the anti-ageing agent into the dispersion. Suitable concentrations lie in the range of from 0.1 to 5 parts by weight, based on the solids.

To improve the processing properties, further conventional processing aids, such as rheology additives (thickeners), defoamers, deaerators, wetting agents or flow agents, can be added to the pressure-sensitive adhesive composition for formulation. Suitable concentrations lie in the range of from 0.1 to 5 parts by weight, based on the solids.

Fillers (reinforcing or non-reinforcing), such as silicon dioxides (spherical, needle-shaped, platelet-shaped or irregular, such as the pyrogenically produced silicas), glass as solid or hollow balls, microballoons, calcium carbonates, zinc oxides, titanium dioxides, aluminium oxides or aluminium oxide hydroxides, can serve both for adjusting the processability and the adhesive properties. Suitable concentrations lie in the range of from 0.1 to 20 parts by weight, based on the solids.

According to preferred embodiments, the pressure-sensitive adhesive composition according to the invention has, in accordance with ASTM D3330, an adhesive strength on steel of greater than 5.1 N/cm at a weight per unit area of the pressure-sensitive adhesive composition of less than 100 g/m², preferably on a PET woven fabric as the carrier, particularly preferably with the weights per unit area mentioned for the woven fabric, and particularly preferably the pressure-sensitive adhesive composition has an adhesive strength of greater than or at least 5.6 N/cm (at a weight per unit area of the pressure-sensitive adhesive composition of less than 90 g/m² on polyester woven fabric as the carrier, preferably also already at less than 80 g/m², particularly preferably at less than 70 g/m² on polyester woven fabric as the carrier).

Preferably, according to the invention, the carrier is a textile carrier, preferably a woven fabric, in particular a polyester woven fabric, a nonwoven or a knitted fabric, and in this context it is further preferable if the carrier has a weight per unit area of from 30 to 250 g/m², preferably from 50 to 200 g/m², particularly preferably from 60 to 150 g/m².

All the known textile carriers can be used as the carrier, such as stitched fabric, fibre woven fabric, tapes, braided fabric, tufted textiles, felts, woven fabric (including linen, twill and satin weave), knitted fabric (including warp knitting goods and knitted stitched goods) or nonwovens, “nonwoven” being understood as meaning at least textile sheet-like structures according to EN 29092 (1988) and stitch-bonded nonwovens and similar systems.

Spacer woven fabric and knitted fabric with lamination can likewise be used. Such spacer woven fabrics are disclosed in EP 0 071 212 B1. Spacer woven fabrics are mat-like laminar bodies having a top layer of a fibre or filament nonwoven, an underlay layer and, present between these layers, individual or clusters of holding fibres which, distributed over the area of the laminar body, are needle-punched through the particle layer and join the top layer and the underlay layer to one another. According to EP 0 071 212 B1, particles of inert stone particles, such as, for example, sand, gravel or the like, are present in the holding fibres as an additional but not necessary feature.

The holding fibres needle-punched through the particle layer hold the top layer and the underlay layer at a distance from one another and they are joined to the top layer and the underlay layer.

Possible nonwoven materials are, in particular, bonded staple fibre nonwovens, but also filament, melt-blown and spun nonwovens, which usually additionally have to be bonded. Possible bonding methods known for nonwovens are mechanical, thermal and chemical bonding. While in mechanical bonding the fibres are usually held together purely mechanically by fluidizing the individual fibres, by meshing fibre bundles or by sewing in additional threads, adhesive (with binders) or cohesive (binder-free) fibre-fibre bonds can be achieved by thermal and also by chemical processes. With a suitable recipe and process procedure, these can be limited exclusively or at least predominantly to fibre knot points, so that while retaining the loose, open structure in the nonwoven, a stable, three-dimensional network is nevertheless formed.

Nonwovens which are bonded in particular by oversewing with separate threads or by meshing have proved to be particularly advantageous.

Such bonded nonwovens are produced, for example, on stitch-bonding machines of “Malimo” type from the company Karl Mayer, formerly Malimo, and can be obtained, inter alia, from the company Techtex GmbH. A Mali nonwoven is characterized in that a transverse fibre nonwoven is bonded by the formation of stitches from fibres of the nonwoven.

A nonwoven of the Kunit or Multiknit can furthermore be used as the carrier. A Kunit nonwoven is characterized in that it originates from the processing of a longitudinally orientated fibre nonwoven to give a sheet-like structure, which has stitches on one side and stitching stays or pile fibre folds on the other, but has neither threads nor prefabricated sheet-like structures. Such a nonwoven has also been produced for a relatively long time, for example, on stitch-bonding machines of the “Malimo” type from the company Karl Mayer. A further characterizing feature of this nonwoven is that as a longitudinal fibre nonwoven it can absorb high tensile forces in the longitudinal direction. A Multiknit nonwoven is characterized in contrast to the Kunit nonwoven in that the nonwoven undergoes bonding by needle-punching on both sides both on the upper side and on the underside. As a rule one or two pile fibre nonwoven stitch-bonded materials meshed on one side and produced by the Kunit process serve as the starting product for a Multiknit. In the end product the two nonwoven upper sides are formed to a closed surface by fibre meshing, and joined to one another by virtually perpendicular fibres. The additional ability to introduce further punchable sheet-like structures and/or scatterable media exists.

Finally, stitched nonwovens are also suitable as a precursor for forming a carrier according to the invention and an adhesive tape according to the invention. A stitched nonwoven is formed from a nonwoven material with a large number of seams running parallel to one another. These seams are formed by sewing in or stitch-bonding continuous textile threads. Stitch-bonding machines of the “Malimo” type from the company Karl Mayer are known for this type of nonwoven.

Needle-punched nonwovens are also particularly suitable. In a needle-punched nonwoven, a fibre web is made into a sheet-like structure with the aid of needles provided with barbs. By alternately punching in and withdrawing the needles, the material is bonded on a needle bar, the individual fibres interlacing to give a solid sheet-like structure. The number and configuration of the needle-punching points (needle shape, penetration depth, needle-punching on both sides) determine the thickness and strength of the fibre structures, which as a rule are lightweight, permeable to air and elastic.

A staple fibre nonwoven which is prebonded by mechanical working in the first step or which is a wet-laid nonwoven which has been laid hydrodynamically, between 2 wt. % and 50 wt. % of the fibres of the nonwoven being fusible fibres, in particular between 5 wt. % and 40 wt. % of the fibres of the nonwoven, is furthermore particularly advantageous. Such a nonwoven is characterized in that the fibres are wet-laid or, for example, a staple fibre nonwoven is prebonded by the formation of stitches of fibres of the nonwoven by needle-punching, sewing, or air and/or water jet treatment. In a second step thermofixing takes place, the strength of the nonwoven being increased further by melting or superficial melting of the fusible fibres.

For the use according to the invention of nonwovens, adhesive bonding of mechanically prebonded or wet-laid nonwovens is of interest in particular, it being possible for this to be carried out via addition of binder in solid, liquid, foamed or paste form. The main presentation forms have various possibilities, for example solid binders as powder for trickling in, as a film or as a mesh or in the form of binding fibres. Liquid binders can be applied as a solution in water or organic solvents or as a dispersion. Binding dispersions are predominantly chosen for adhesive bonding: Thermosets in the form of phenolic or melamine resin dispersions, elastomers as dispersions of natural or synthetic rubbers or usually dispersions of thermoplastics, such as acrylates, vinyl acetates, polyurethanes, styrene/butadiene systems, PVC and the like and copolymers thereof. In the normal case in this context these are anionic or nonionically stabilized dispersions, but in special cases cationic dispersions may also be of advantage.

The binder application can be carried out in a manner according to the prior art and reference to this can be found, for example, in standard works of coating or of nonwoven technology, such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically prebonded nonwovens which already have an adequate bonded strength, one-sided spray application of a binder is suitable for modifying surface properties in a targeted manner. In addition to economical handling of the binder, the energy requirement for drying is also reduced significantly with such a procedure. Since no squeeze rollers are required and the dispersions predominantly remain in the upper region of the nonwoven, an undesirable hardening and stiffening of the nonwoven can be largely prevented. For a sufficient adhesive bonding of the nonwoven carrier, binder is in general to be added in the order of from 1% to 50%, in particular 3% to 20%, based on the weight of the fibre nonwoven.

The addition of the binder can already be carried out during the nonwoven production, during the mechanical prebonding or in a separate process step, it being possible for this to be carried out in-line or off-line. After the addition of the binder, a state must temporarily be generated for the binder in which this becomes tacky and bonds the fibres adhesively—which can be achieved during the drying, for example, of dispersions, but also by heating, further possible variations existing via application of pressure over the surface or part of the surface. The activation of the binder can be carried out in known drying tunnels, but with a suitable choice of binder also by means of infra-red radiation, UV radiation, ultrasound, high-frequency radiation or the like. For the later end use it is appropriate, but not absolutely necessary, for the binder to have lost its tackiness after the end of the nonwoven production process. It is advantageous that due to the thermal treatment volatile components, such as fibre auxiliary substances, are removed and a nonwoven having favourable fogging values is thus formed, so that if a low-fogging adhesive composition is employed, an adhesive tape having particularly favourable fogging values can be produced, and likewise the carrier thus also has a very low fogging value.

A further special form of adhesive bonding comprises activation of the binder by superficial dissolving or swelling. In principle, the fibres themselves or admixed special fibres can also take over the function of the binder here. However, since for most polymeric fibres such solvents are unacceptable from environmental aspects or present handling problems, this process is rather less often used.

Advantageously and at least in regions, the carrier has a smoothed surface on one or both sides, preferably in each case a smoothed surface over the entire area. The smoothed surface may have been given a chintz treatment, as is explained, for example, in EP 1 448 744 A1. The dirt repellency is improved in this manner.

Starting materials envisaged for the carrier are, in particular, (manmade) fibres (staple fibre or continuous filament) of synthetic polymers, also called synthetic fibres, of polyester, polyamide, polyimide, aramid, polyolefin, polyacrylonitrile or glass, (manmade) fibres of natural polymers, such as cellulosic fibres (viscose, Modal, Lyocell, Cupro, acetate, triacetate, Cellulon), such as rubber fibres, such as vegetable protein fibres and/or such as animal protein fibres and/or natural fibres of cotton, sisal, flax, silk, hemp, linen, coconut or wool. However, the present invention is not limited to the materials mentioned, but a large number of further fibres, as is evident to the person skilled in the art without having to take an inventive step, can be employed for production of the nonwoven. Yarns produced from the abovementioned fibre materials furthermore are likewise suitable.

In the case of woven fabrics or laid fabrics, individual threads can be produced from a blended yarn, that is to say can have synthetic and natural constituents. As a rule the warp threads and the weft threads, however, are in each case formed from the same variety.

The warp threads and/or the weft threads in this context can in each case be made only of synthetic threads or of threads of natural raw materials.

Polyester is preferred as the material for the carrier because of the outstanding resistance to ageing and the outstanding media resistance to chemicals and operating agents, such as oil, petrol, antifreeze and the like. Polyester moreover has the advantages that it leads to a very abrasion-resistant and temperature-resistant carrier, which is of particular importance for the specific intended purpose for bundling cables in automobiles and, for example, in the engine compartment.

A carrier which is made of paper, a laminate, a film (for example PP, PE, PET, PA, PU), foam or a foamed film is also suitable for sheathing the elongated goods.

These non-textile planar materials are appropriate in particular if specific requirements require such a modification of the invention. Films, for example, are usually thinner compared with textiles, due to the closed layer they offer additional protection against the penetration of chemicals and operating agents, such as oil, petrol, antifreeze and the like, into the actual cable region, and they can be largely adapted to requirements via suitable choice of the material: for example, with polyurethanes or copolymers of polyolefins flexible and elastic sheathings can be produced, with polyester and polyamides good abrasion and temperature resistances are achieved.

Foams or foamed films, on the other hand, have the property of filling more space and good sound-proofing—for example if a cable strand is laid in a conduit- or tunnel-like region in the vehicle, troublesome rattling and vibration can be suppressed from the beginning by a sheathing tape of suitable thickness and damping properties.

Finally, the adhesive tape can have a covering material, with which the one or the two layers of adhesive composition can be covered until used. All the materials listed above in detail are also suitable as covering materials.

Preferably, a non-fuzzing material is employed, such as a film of plastic or a well-sized, long-fibred paper.

If flame resistance of the adhesive tape described is desired, this can be achieved by adding flameproofing agents to the carrier and/or the adhesive composition. These can be organobromine compounds, if required with synergists such as antimony trioxide, but in view of the absence of halogen in the adhesive tape red phosphorus, organophosphorus, mineral or intumescent compounds, such as ammonium polyphosphate, by themselves or in combination with synergists, are preferably used.

Particularly advantageous embodiments of the invention include the following adhesive tape variants:

### Variant A

Carrier material:
   Woven fabric having a weight per unit area of from 100 to 200 g/m² and having a permeability to air (the air stream is stated) of less than 80 l/m²/s, preferably less than 60 l/m²/s (measured in accordance with DIN EN ISO 9237 (test area 20 cm², pressure difference used 200 Pa, test climate of 23±1° C. and 50±5% rel. atmospheric humidity))
Adhesive composition:
   Pressure-sensitive adhesive composition in the form of a dried and electron beam (EBC)-crosslinked polymeric acrylate dispersion having a weight per unit area of from 60 to 120 g/m², the dose for crosslinking being between 30 to 50 kGy.
   The shear viscosity of the pressure-sensitive adhesive composition at a temperature of 25° C. during the coating from dispersion is 200 to 100,000 Pa*s at a shear rate of 10⁻² s⁻¹ and 0.1 to 10 Pa*s at a shear rate of 100 s⁻¹.
Adhesive tape
   Flexural strength in MD (machine direction) of less than 25 mN/60 mm (measured with a Softometer KWS basic 2000 mN measuring apparatus from the company Wolf Messtechnik GmbH)

### Variant B

Carrier material:
   Woven fabric having a weight per unit area of from 50 to 100 g/m² and having a permeability to air (the air stream is stated) of less than 80 l/m²/s, preferably less than 60 l/m²/s (measured in accordance with DIN EN ISO 9237 (test area 20 cm², pressure difference used 200 Pa, test climate of 23±1° C. and 50±5% rel. atmospheric humidity))
Adhesive composition:
   Pressure-sensitive adhesive composition in the form of a dried and electron beam (EBC)-crosslinked polymeric acrylate dispersion having a weight per unit area of from 50 to 100 g/m², the dose for crosslinking being between 5 to 25 kGy.
   The shear viscosity of the pressure-sensitive adhesive composition at a temperature of 25° C. during the coating from dispersion is 200 to 100,000 Pa*s at a shear rate of 10⁻² s⁻¹ and 0.1 to 10 Pa*s at a shear rate of 100 s⁻¹.
Adhesive tape
   Flexural strength in MD (machine direction) of less than 15 mN/60 mm (measured with a Softometer KWS basic 2000 mN measuring apparatus from the company Wolf Messtechnik GmbH)

The general expression “adhesive tape” in the context of this invention includes all sheet-like structures, such as film or film sections extended in two dimensions, tapes having an extended length and limited width, tape sections and the like, finally also stamped-out goods or labels.

The adhesive tape can be produced in the form of a roll, that is to say rolled up on itself in the form of an archimedic spiral. A reverse side lacquer can be applied to the reverse side of the adhesive tape in order to favourably influence the unrolling properties of the adhesive tape wound to the archimedic spiral. For this, this reverse side lacquer can be treated with silicone compounds or fluorosilicone compounds and with polyvinylstearyl carbamate, polyethyleneiminestearylcarbamide or organofluorine compounds as substances having an abhesive action or for non-stick coating.

The adhesive composition can be applied in the longitudinal direction of the adhesive tape in the form of a strip which has a smaller width than the carrier of the adhesive tape.

Depending on the case in use, several parallel strips of the adhesive can also be coated onto the carrier material. The position of the strip on the carrier can be freely chosen, an arrangement directly on one of the edges of the carrier being preferred.

Preferably, the adhesive composition is applied over the entire area of the carrier.

At least one strip of a covering which extends in the longitudinal direction of the adhesive tape and which covers between 20% and 90% of the adhesive coating can be provided on the adhesive coating of the carrier. Preferably, the strip covers in total between 50% and 80% of the adhesive coating. The degree of covering is chosen as a function of the use and of the diameter of the cable loom. The percentage figures stated relate to the width of the strip of the covering with respect to the width of the carrier.

According to a preferred embodiment of the invention, exactly one strip of the covering is present on the adhesive coating.

The position of the strip on the adhesive coating can be freely chosen, an arrangement directly on one of the longitudinal edges of the carrier being preferred. In this manner, an adhesive strip which extends in the longitudinal direction of the adhesive tape and which seals with the other longitudinal edge of the carrier results. If the adhesive tape is employed for sheathing a cable harness by leading the adhesive tape around the cable harness in a helical movement, the enveloping of the cable harness can take place such that the adhesive composition of the adhesive tape is stuck only on to the adhesive tape itself, while the goods do not come into contact with adhesive. The cable harness sheathed in this way has a very high flexibility due to the absence of fixing to the cable by any adhesive. Its bendability during installation—precisely also in narrow passages or sharp bends—is thus increased significantly.

If a certain fixing of the adhesive tape on the goods is desired, the sheathing can be effected such that the adhesive strip is stuck partly on the adhesive tape itself and otherwise partly on the goods. According to another advantageous embodiment, the strip is applied centrally to the adhesive coating, so that two adhesive strips extending on the longitudinal edges of the carrier in the longitudinal direction of the adhesive tape result.

For reliable and economical application of the adhesive tape around the cable harness in the said helical movement and against slipping of the resulting protective envelope, the two adhesive strips present in each case on the longitudinal edges of the adhesive tape are advantageous, especially if one, which is usually narrower than the second strip, serves as a fixing aid and the second, wider strip serves as a closure. In this manner the adhesive tape is stuck on the cable such that the cable loom is secured against slipping and nevertheless is flexible in configuration. In addition, there are embodiments in which more than one strip of the covering is applied to the adhesive coating. If only one strip is referred to, the person skilled in the art interprets this as meaning that it is entirely possible for several strips also to cover the adhesive coating simultaneously.

The invention likewise provides a process for the production of an adhesive tape, in particular for wrapping cables, from a textile carrier and a pressure-sensitive adhesive composition which is applied to at least one side of the carrier, and an adhesive tape obtainable by this process, in which the pressure-sensitive adhesive composition
is applied to at least one side of the textile carrier,
the pressure-sensitive adhesive composition is optionally dried,
the pressure-sensitive adhesive composition is crosslinked with electron beams, wherein
   preferably the carrier is arranged on the side of the pressure-sensitive adhesive composition facing away from the electron beam source, in particular the electron beam crosslinking (EBC) is carried out with 0.001 to 80 kGy, preferably with 5 to 80 kGy, particularly preferably with 10 to 50 kGy, depending on the pressure-sensitive adhesive composition the crosslinking is carried out with 5 to 20 kGy or alternatively with 20 to 50 kGy, further preferably the side of the pressure-sensitive adhesive composition facing away from the carrier material is irradiated with electron beams (EBC), in particular the dose is 5 to 50 kGy, in particular 5 to 45 kGy, depending on the pressure-sensitive adhesive composition 5 to 20 kGy or alternatively 20 to 50 kGy,
      wherein the pressure-sensitive adhesive composition comprises a polymeric acrylate dispersion and between 15 and 100 parts by weight of a tackifier (based on the weight of the dried polymeric dispersion).

According to the invention, the pressure-sensitive adhesive composition is crosslinked directly with electron beams, so that the pressure-sensitive adhesive composition is not crosslinked by means of electron beams through the carrier side, but the electron beam source is directly facing the non-covered pressure-sensitive adhesive composition.

Possible carriers are the abovementioned carriers, and preferably a planar textile carrier is used, preferably a woven fabric, such as a polyester woven fabric, a nonwoven or a knitted fabric, the weight per unit area thereof preferably extending from 30 to 250 g/m², preferably 50 to 200 g/m², further preferably 60 to 150 g/m².

According to the invention, an acrylate dispersion which is preferably an aqueous acrylate dispersion, in particular an acrylate dispersion prepared by the process of emulsion polymerization, based on the abovementioned monomers and comonomers, as described above, is employed in the pressure-sensitive adhesive composition. In addition, rheology additives can be added to the pressure-sensitive adhesive composition.

As explained above, the pressure-sensitive adhesive composition can furthermore comprise as tackifiers adhesive resins having a softening point above 80° C. according to ASTM E28-99 (2009), preferably resins based on terpene phenols and/or rosin esters having a softening point above 90° C. according to ASTM E28-99 (2009).

The production process for the adhesive tape according to the invention comprises coating of the carrier directly with the pressure-sensitive adhesive composition in one or more working operations carried out successively. In the case of textile carriers, the non-treated textile can be coated directly or by the transfer process. Alternatively, the textile can be pretreated with a coating or impregnation (with any desired film-forming substance from solution, dispersion, melt and/or radiation-curing), in order then to be provided with the pressure-sensitive adhesive composition directly or by the transfer process in a subsequent working step. Application units which are employed are the conventional: wire doctor, coating beam, roller application, nozzle coating, double chamber doctor, multiple cascade nozzle.

The invention likewise provides an adhesive tape which has a pressure-sensitive adhesive composition which is crosslinked with electron beams (EBC) and comprises an acrylate dispersion and a tackifier, wherein the adhesive tape has a TFT value of greater than 1,500 minutes, preferably greater than 2,000 minutes. This adhesive tape can be equipped with an impregnation layer, in particular based on an acrylate dispersion, between the carrier and pressure-sensitive adhesive composition.

The invention also provides the use of electron beams for crosslinking pressure-sensitive adhesive compositions comprising acrylate dispersions on carriers of adhesive tapes, in particular of adhesive tapes which are suitable for wrapping cables, in particular the use for wrapping cables in the automotive sector, such as cable looms in motor vehicles, and generally cables which are exposed to particular influences such as heat and/or humidity, such as cables which are installed in wind power installations, for example offshore wind parks, etc. The invention thus also provides the use of electron beam (EBC)-crosslinked adhesive tapes according to the invention, produced by the process according to the invention, for wrapping cables, in particular cables which are exposed to elevated temperature and/or humidity. On the basis of the positive properties described, the adhesive tape can be of outstanding use for insulating and wrapping wires or cables.

The invention also provides the use of an adhesive tape according to the invention or adhesive tape produced according to the invention for sheathing elongated goods, wherein the adhesive tape is led around the elongated goods in a helical line, in particular the elongated goods are enveloped by the tape in the axial direction. In addition, the invention provides elongated goods, such as, in particular, a cable loom, sheathed with an adhesive tape according to the invention.

On the basis of the outstanding suitability of the adhesive tape, it can be used in a sheathing which comprises a covering, in which at least in one edge region of the covering the self-adhesive adhesive tape is present, which is stuck on the covering such that the adhesive tape extends over one of the longitudinal edges of the covering, and indeed preferably in an edge region which is narrow compared with the width of the covering. Such a product and optimized embodiments thereof are disclosed in EP 1 312 097 A1. EP 1 300 452 A2, DE 102 29 527 A1 and WO 2006/108871 A1 present further developments for which the adhesive tape according to the invention is likewise very particularly suitable. The adhesive tape according to the invention can likewise be used in a process such as is disclosed in EP 1 367 608 A2. Finally, EP 1 315 781 A1 and DE 103 29 994 A1 describe embodiments of adhesive tapes such as are also possible for the adhesive tape according to the invention.

Further preferably, when stuck on cables with PVC sheathing and on cables with polyolefin sheathing, the adhesive tape does not destroy the same when an assembly of cables and adhesive tape is stored in accordance with LV 312 at temperatures above 100° C. and up to 3,000 h and the cables are then bent around a mandrel. The adhesive tape according to the invention is outstandingly suitable for wrapping cables, can easily be unwound for easy processing, shows no or only slight flagging and shows no embrittlement of the cable even in the high temperature classes of T3 and T4 over 3,000 h.

### BRIEF DESCRIPTION OF THE DRAWINGS

The adhesive tape is to be explained in more detail in the following with the aid of several figures by way of example, without limiting the invention to these embodiments.

The figures show:

FIG. 1 the adhesive tape in side section,

FIG. 2 a section of a cable harness which is composed of a bundle of individual cables and is sheathed with the adhesive tape according to the invention, and

FIG. 3 an advantageous use of the adhesive tape.

FIGS. 4-7 measurement of flagging resistance in accordance with LV 312 or by the TFT method

FIG. 8 dependency of the adhesive strength on the crosslinking, course of adhesive strength (N/cm) vs EBC dose (kGy), Example 1

FIG. 9 dependency of the TFT time on the crosslinking in adhesive strength (N/cm) vs EBC dose (kGy)

FIG. 10 interaction of cohesion and adhesion on detachment of the end of the tape

FIG. 11 influence of EBC crosslinking on the viscosity (measured by the DMA method)

FIG. 12 frequency sweep 25° C. vs tan delta

FIG. 13 influence of EBC crosslinking on the glass transition point

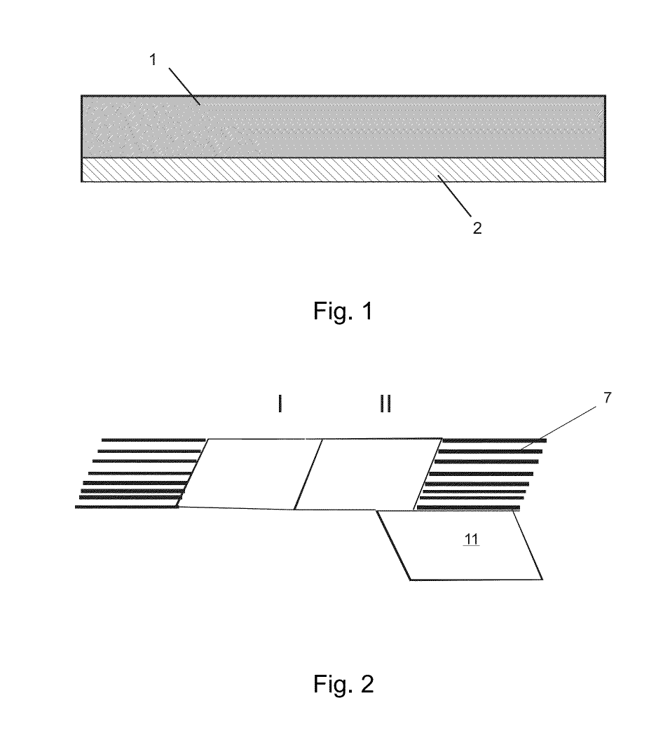

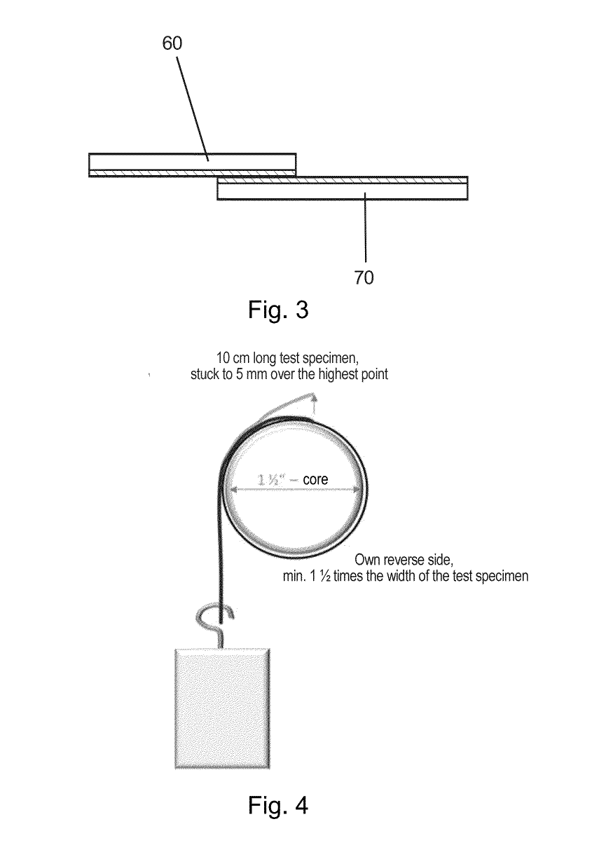

FIG. 1 shows in section in the transverse direction (cross section) the adhesive tape, which comprises a woven carrier 1, onto which a layer of a self-adhesive coating 2 is applied on one side. FIG. 2 shows a section of a cable harness which is composed of a bundle of individual cables 7 and is sheathed with the adhesive tape 11 according to the invention. The adhesive tape is led around the cable harness in a helical movement. The section of the cable harness shown shows two wrappings I and II of the adhesive tape. Towards the left further wrappings would extend, which are not shown here. In a further embodiment for a sheathing, two tapes 60, 70 according to the invention treated with an adhesive composition are laminated on one another with their adhesive compositions displaced (preferably by in each case 50%), so that a product such as is shown in FIG. 3 results.

### EXAMPLES

### Outline of the Examples

The adhesive tape according to the invention is described in the following in a preferred embodiment with the aid of several examples, without thereby limiting the invention in any way. Comparative examples in which adhesive tapes which are not according to the invention are presented are furthermore described.

For explanation of the invention, examples of adhesive tapes were produced in accordance with the following plan: The pressure-sensitive adhesive dispersions were mixed from the polymer and resin dispersion in accordance with the examples of recipes and were intimately homogenized with a stirrer. The pressure-sensitive adhesive dispersions were then adjusted to a viscosity of approx. 5,000 Pa*s at a shear rate of 0.01 s⁻¹ (measured with cone/plate geometry in rotary mode with a DSR 200 N rheometer from Rheometric Scientific) by stirring in a polyurethane associative thickener (Borchigel 0625, OMG Borchers). Using a film drawing unit, a polyester woven fabric (according to the data in the examples) was optionally coated according to the data in the example with the thickened example of pressure-sensitive adhesive dispersion such that after drying in a circulating air oven at 85° C. for 5 minutes an adhesive composition weight per unit area of approx. 20 g/m² resulted. The woven fabric impregnated in this manner was coated analogously with the same dispersion in a second working step, so that after drying in a circulating air oven at 85° C. for 10 minutes a total adhesive composition weight per unit area of 60, 70 or 90 g/m² or corresponding to the data in the examples resulted.

### Evaluation Criteria:

The criterion for an adhesive tape suitable for use for wrapping cables in the present case is the flagging resistance according to the TFT test. The good unrolling force from the roll after storage at 40° C. for 4 weeks and the cable compatibility according to LV 312 can be found for the non-EBC-crosslinked pressure-sensitive adhesive compositions in the abovementioned German patent applications (page 6).

Test procedure: The measurements were—unless expressly mentioned otherwise—carried out under a test climate of 23±1° C. and 50±5% rel. atmospheric humidity.

Measurement of the flagging resistance in accordance with LV 312 or by the TFT method (threshold flagging time): To determine the flagging behaviour by the TFT method, a test in which an additional flexural stress is generated by application of the test specimens prepared in planar form to a 1½″ core is employed. The combination of tensile load due to a test weight and flexural stress has the effect of a flagging-like detachment of the adhesive tape starting from the stuck upper end and a final failure by the test specimen falling off (see FIG. 4, in which a diagram of the set-up is also shown). The time in minutes until the falling off is the result. The decisive parameters for the holding time of the test specimens are weight and temperature, the weight being chosen such that values of at least 100 min result.

The cylindrically shaped test mandrel is a 1½″ cardboard core of 42±2 mm external diameter, provided with a marking line 5 mm alongside the vertical line.

The adherend base is the adhesive tape's own reverse side.

The hand roller has a weight of 2 kg.

The test weight is 1 kg.

The test climate is 23±1° C. at 50±5% rel. humidity or 40° C. in the heating cabinet.

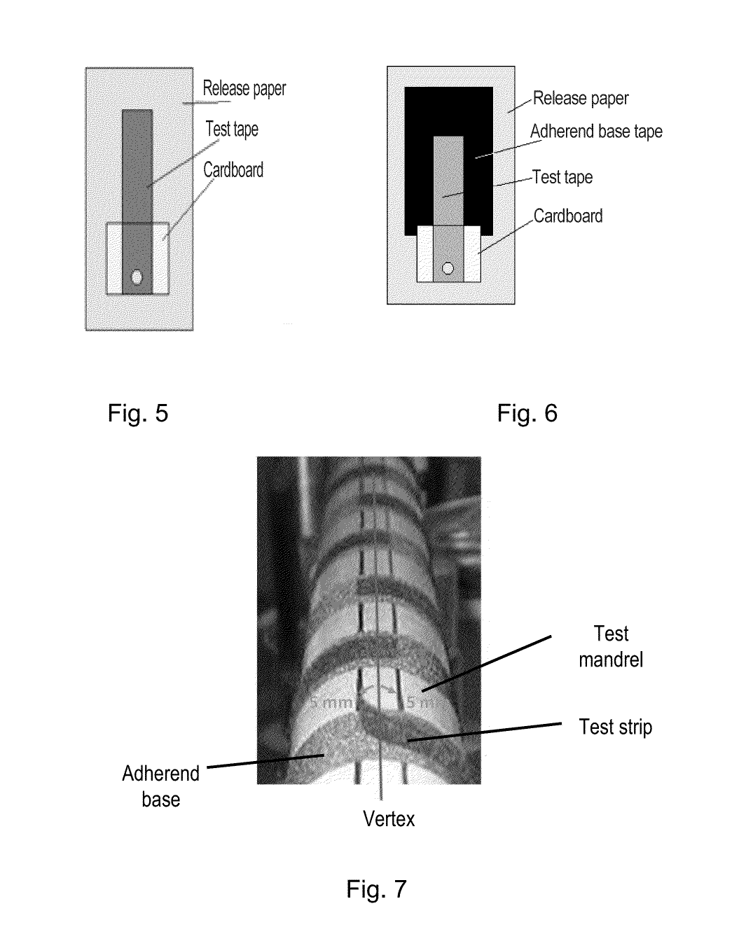

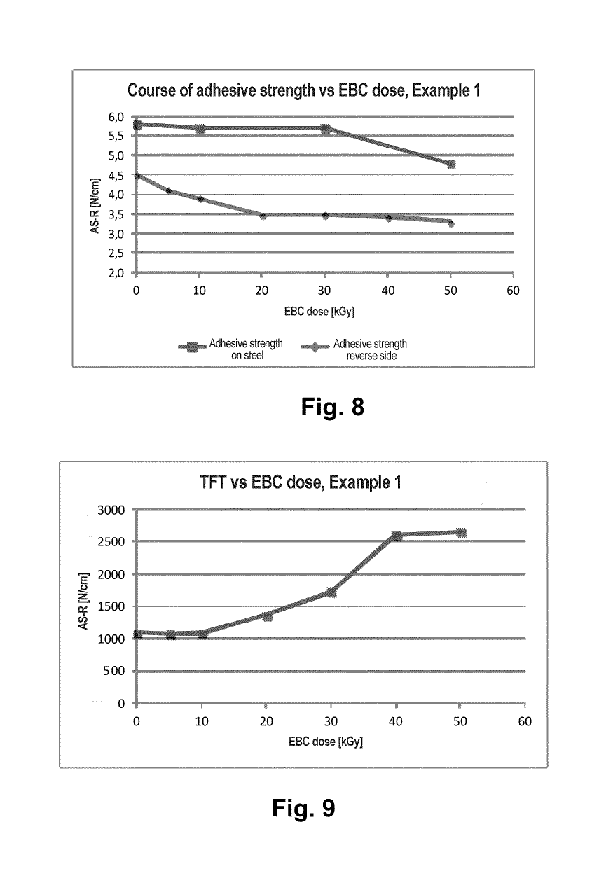

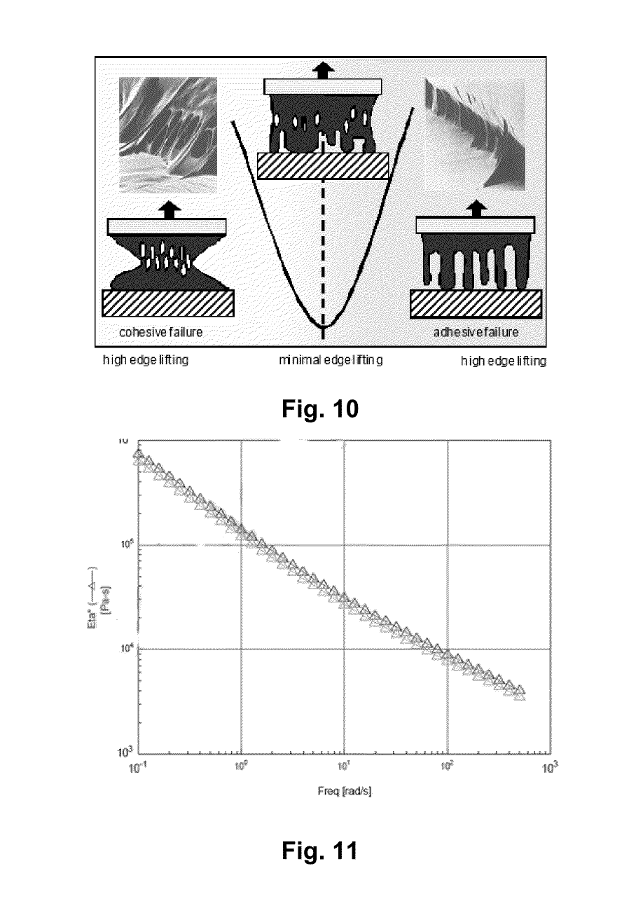

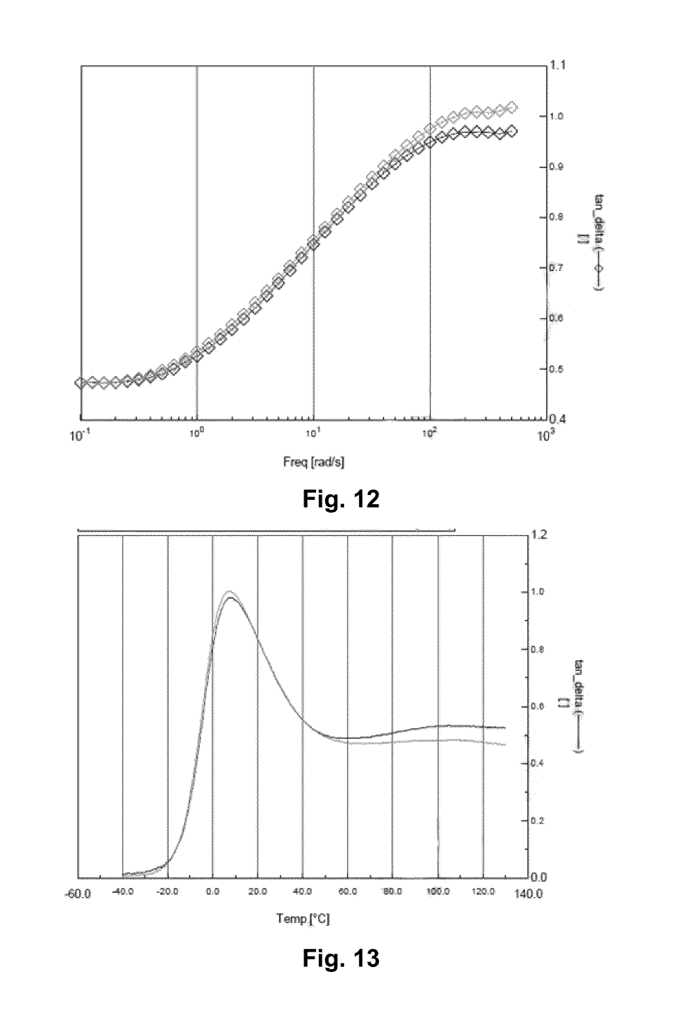

Testing is carried out on strips of adhesive tapes 19 mm wide. A strip of 400 mm length is stuck onto release paper and cut into three strips each of 100 mm length. A fresh cutter blade is to be used here. The reverse side should not be touched. A cardboard card is stuck under one of the ends of each strip and the assembly is perforated (see FIG. 5). The test strips are now individually stuck centrally on strips of the wider adherend base (adhesive tape of 1½ times the width of the adhesive tape to be tested) so that the cardboard card still just overlaps (2 to 3 mm) at the end (see FIG. 6). The test specimens are rolled over with the 2 kg hand roller in 3 cycles with a speed of 10 m/min. The finished test samples, that is to say the test strips together with the adherend base, are now stuck onto the cardboard core such that the upper end of the test specimen overlaps the vertex by 5 mm (see FIG. 7). Pressure should be put here only on the adherend base and not the test specimen. The ready-prepared test specimens are left in a climatically controlled chamber at 40° C. without a weight load for 20±4 hours.

Thereafter, weights of one kilogram are hung on and the recording clock is started. The measurement ends after failure of all three test specimens of a sample. The median of the three individual measurements is stated in minutes. The holding time is stated in minutes. In this context, a TFT value of >1,000 minutes, preferably greater than 1,200 minutes, particularly preferably greater than 2,000 minutes is regarded as the lower limit of the resistance to flagging.

Softening point: Measurement in accordance with ASTM E28-99 (2009)

The flexural strength is determined with a Softometer KWS basic 2000 mN (company Wolf Messtechnik GmbH). (MD) stands for machine direction, i.e. the flexural strength was determined in the machine direction.

Gel value: The gel value is determined by Soxhlet extraction, via which soluble constituents are extracted from polymers in a continuous extraction. In the case of the gel value determination of (water-borne) polyacrylate pressure-sensitive adhesive compositions, the soluble contents of a polymer—of the so-called sol—are extracted from the insoluble contents—the so-called gel—by a suitable solvent, such as, for example, tetrahydrofuran. Preparation: The composition to be extracted is applied in a thin film to siliconized release paper—as a rule 120 μm layer thickness—and dried at 80° C. for about 12 h (circulating air drying cabinet). The films are stored in a desiccator over a drying agent. The extraction thimbles type 603 from Whatman are dried at 80° C. for 12 h, the empty weight of the thimbles is determined and the thimbles are stored in the desiccator until used. Gel value determination: approx. 1 g of pressure-sensitive adhesive composition is weighed into the extraction thimble. A 100 ml round-bottomed flask of the Soxhlet apparatus is filled with 60 ml of tetrahydrofuran and heated to the boiling point. THF vapours rise through the vapour tube of the Soxhlet apparatus and condense in the condenser and THF drips into the extraction thimble and extracts the sol content. In the course of the extraction, the THF I runs back into the flask with the extracted sol. Dissolved sol increasingly accumulates in the flask. After 72 h of continuous extraction, the sol is completely dissolved in the THF. The extraction thimble is now—after cooling of the apparatus to room temperature—removed and dried at 80° C. for 12 h. The thimbles are stored in the desiccator to constant weight and then weighed.

The gel value of the polymer is calculated with the aid of the following formula:

$$Gel value = \frac{{m}_{3} - {m}_{1}}{{m}_{2} - {m}_{1}} \cdot 100 \%$$

where m₁: weight of extraction thimble, empty
m₂: weight of extraction thimble+polymer
m₃: weight of extraction thimble+gel

Viscosity measurement by DMA (dynamic mechanical analysis): In order to determine whether the cohesion of the pressure-sensitive adhesive composition can be improved by the EBC irradiation in order to minimize penetration of the composition into the reverse side of the woven fabric during wrapping, rheology investigations were carried out.

Measuring apparatus RDA III (Bruker), 2,000 g spring-mounted with normal force,

temperature control: oven, measurement geometry: parallel sheets; diameter: 25 mm;
frequency sweep: 0.1 rad/s to 512 rad/s, temp.: 25° C., deformation: 3%;
heating-up rate: 2.5° C./min, deformation: 1%

For determination of the rheology by means of the frequency sweep at RT (25° C.), the samples of the EBC-irradiated and non-irradiated adhesive tapes were stamped out in each case in three layers one on top of the other with a 25 mm wad punch and the abraded reverse sides were stuck by means of superglue. The frequency sweep was carried out over 0.1 to 512 rad/s; the tan delta and the complex viscosity |η|* at 0.1 and 100 rad/s and the crossover point were evaluated.

Measurement of the adhesive strength: For measurement of the adhesive strength of the pure dispersions, smears of the adhesive compositions were first prepared. For this, the dispersions were introduced onto a PET film (polyethylene terephthalate) having a thickness of 23 μm and spread with a film drawing apparatus such that after drying at 105° C. for 5 minutes in a circulating air drying cabinet an adhesive composition weight per unit area of 30 g/m² resulted.

Strips of 20 mm width and 25 cm length were cut out of this leaf with a cutter blade. For the measurement of the adhesive strength of the formulations with resin, smears on polyester woven fabric were used as described above and likewise cut into strips of 20 mm width and 25 cm length with a cutter blade. The adhesive strength on steel of the EBC-crosslinked samples was measured in accordance with ASTM D3330.

Measurement of the glass transition temperatures: The glass transition temperatures were determined on the DSC 204 F1 “Phönix” dynamic differential calorimeter apparatus from the company Netzsch, Germany in 25 μl aluminium crucibles with a perforated lid under a nitrogen atmosphere (20 ml/min gas flow). The sample weight was 8±1 mg. The samples were measured twice from −140° C. to 200° C. with a heating rate of 10 K/min. The 2nd heating-up curve was evaluated. The method is based on DIN 53 765.

### Composition of a Polymer Dispersion According to the Invention:

| Monomer | Polymer 1 |
|---|---|
| 2-Ethylhexyl acrylate | 93 |
| Butyl acrylate | |
| Acrylic acid | 4 |
| Acrylonitrile | 3 |
| Methyl methacrylate | — |
| Vinyl acetate | — |

The glass transition temperatures of polymer 1 (stated in ° C.): −47

The pressure-sensitive adhesive compositions listed in Table 1 were formulated from polymer 1 by blending with adhesive resin dispersions.

TABLE 1
Pressure-sensitive adhesive composition comprising polymer 1

| | |
|---|---|
| Polymer 1 | 70 wt. % |
| Rosin ester resin | 30 wt. % |
| Snowtack 100G, Lawter | |

The rosin ester resin Snowtack 100G, Lawter, has a softening point of 99° C.

The glass transition temperature of the pressure-sensitive adhesive formulation was determined as the dynamic Tg by means of rheological analysis (temp. sweep) as 7-8° C.

### Example 1

Carrier: PET woven fabric, 130 g/m²
Warp: 48 threads/cm×167 dtex
Weft: 24 threads/cm×167 dtex
   Pressure-sensitive adhesive composition: resin-modified acrylate dispersion, 90 g/m²; (polymer 1 (triple A) with 30 wt. % of rosin ester resin)
   EBC dose: up to 50 kGy (acceleration voltage 200 kV).

The value without EBC crosslinking is also listed for comparison.

### Example 2

Carrier: PET woven fabric, 70 g/m²
Warp: 34 threads/cm×84 dtex
Weft: 28 threads/cm×167 dtex
   Impregnation: acrylate dispersion, 20 g/m²
   Pressure-sensitive adhesive composition: resin-modified acrylate dispersion, 70 g/m²; (polymer 1 (triple A) with 30 wt. % of rosin ester resin)
   EBC dose: up to 30 kGy (acceleration voltage 200 kV).

The value without EBC crosslinking is also listed for comparison.

### Comparative Example 3

Carrier: PET woven fabric, 130 g/m²
Warp: 48 threads/cm×167 dtex
Weft: 24 threads/cm×167 dtex
   Pressure-sensitive adhesive composition: acrylate hot melt (acResin® A 260 UV, BASF), 90 g/m²
   UV dose: 25 mJ/cm²

### Comparative Example 4

Carrier: PET woven fabric, 70 g/m²
Warp: 34 threads/cm×84 dtex
Weft: 28 threads/cm×167 dtex
   Impregnation: acrylate dispersion, 20 g/m²
   Pressure-sensitive adhesive composition: acrylate hot melt (acResin® A 260 UV, BASF), 60 g/m²
   UV dose: 20 mJ/cm₂

TABLE 2

| | | Adhesive | Adhesive strength | |
|---|---|---|---|---|
| | EBC dose | strength on steel | on reverse side | TFT |
| | kGy | N/cm | N/cm | min |
| Values for | 0 | 5.8 | 4.5 | 1,050 |
| Example 1 | 5 | 5.6 | 4.1 | 1,072 |
| | 10 | 5.7 | 3.9 | 1,086 |
| | 20 | 5.5 | 3.5 | 1,363 |
| | 30 | 5.7 | 3.5 | 1,724 |
| | 40 | 5.2 | 3.4 | 2,601 |
| | 50 | 4.8 | 3.3 | 2,654 |
| Values for | 0 | 5.8 | 3.4 | 1,329 |
| Example 2 | 5 | 5.5 | 3.2 | 1,581 |
| | 10 | 5.6 | 3.4 | 2,519 |
| | 20 | 5.5 | 2.8 | 3,485 |
| | 30 | 5.7 | 3.2 | 4,925 |
| Values for | — | 5.5 | 6.5 | 311 |
| Comparative | | | | |
| Example 3 | | | | |
| Values for | — | 5.0 | 4.0 | 172 |
| Comparative | | | | |
| Example 4 | | | | |

The comparison of the two Examples 1 and 2 clearly shows what influence the choice of the carrier material has on the flagging behaviour of the adhesive tape. The product design in both cases is such that the non-crosslinked sample of the particular test series has a TFT value just above 1,000 min. In the case of the flexible, thin carrier material from Example 2, a comparatively low EBC dose of 10 kGy is sufficient to raise the TFT time to above 2,000 min. Furthermore, the TFT time also increases significantly with increasing crosslinking. This example therefore offers excellent prerequisites for an absolutely flagging-free product. In Example 1, on the other hand, a significantly thicker and flexurally more rigid woven fabric carrier was employed. In order to realize the starting value of more than 1,000 min TFT here, a high application of composition of 90 g/m² is already necessary. By crosslinking the composition with 40 kGy, a TFT value of more than 2,000 min is also obtained in this case, which corresponds to an adhesive tape with excellent flagging properties. Nevertheless, it can also be seen from this series that no noticeable further increase in the TFT value by still higher EBC doses is possible.

| | Flexural strength | Flexural strength |
|---|---|---|
| | Untreated carrier (MD)* | Adhesive tape (MD)* |
| | mN/60 mm | mN/60 mm |
| Values for Example 1 | 10 | 18 |
| Values for Example 2 | 2** | 8 |

*The flexural strength of the adhesive tape was determined with a Softometer KWS basic 2000 mN from the company Wolf Messtechnik GmbH
**Without impregnation with acrylate dispersion

On application of the adhesive tapes to a cable harness, the advantage which the acrylate dispersions have with respect to flagging clearly manifests itself. While Comparative Examples 3 and 4 have clearly protruding tape ends of over 5 mm length after storage, the flagging in Examples 1 and 2 is reduced to less than 2 mm. When the corresponding EBC dose is used −40 kGy in Example 1 and 10 kGy in Example 2—flagging is no longer to be found.

Regarding the comparative examples, it is also to be added that the flagging behaviour cannot be controlled particularly well here via the degree of crosslinking. In contrast to the acrylate dispersions, in the acrylate hot melt composition a crosslinking of narrower mesh takes place, which already manifests itself adversely at lower doses of from approx. 15 mJ/cm². Due to the greater crosslinking, the crosslinking capacity of the adhesive composition falls, which manifests itself in the form of lower adhesive strengths and TFT times.

Since the preparation of adhesive tapes which are easy to unroll is possible only from a UV dose of 20 mJ/cm², the adhesive composition cannot be adjusted to the optimum with respect to its flagging properties.

1. Method for wrapping cables which are exposed to elevated temperature and/or humidity, which comprises wrapping said cables with an adhesive tape comprising a textile carrier and a pressure-sensitive adhesive composition which is applied to at least one side of the carrier and is in the form of a dried and electron beam (EBC)-crosslinked polymeric acrylate dispersion, comprising polymers which are built up from
a) monomeric acrylates and optionally
b) ethylenically unsaturated comonomers which are not acrylates,
wherein the pressure-sensitive adhesive composition comprises between 15 and 100 parts by weight of a tackifier, based on the weight of the dried polymeric dispersion, and wherein the pressure-sensitive adhesive has been crosslinked by irradiating the side of the pressure-sensitive adhesive facing away from the carrier with an EBC dose of between 5 and 50 kGy, and the threshold flagging time of the irradiated pressure-sensitive adhesive is greater than 1,000 minutes.

2. Method for sheathing elongated goods, wherein an adhesive tape comprising a textile carrier and a pressure-sensitive adhesive composition which is applied to at least one side of the carrier and is in the form of a dried and electron beam (EBC)-crosslinked polymeric acrylate dispersion, comprising polymers which are built up from
a) monomeric acrylates and optionally
b) ethylenically unsaturated comonomers which are not acrylates,
wherein the pressure-sensitive adhesive composition comprises between 15 and 100 parts by weight of a tackifier, based on the weight of the dried polymeric dispersion, and wherein the pressure-sensitive adhesive has been crosslinked by irradiating the side of the pressure-sensitive adhesive facing away from the carrier with an EBC dose of between 5 and 50 kGy, and the threshold flagging time of the irradiated pressure-sensitive adhesive is greater than 1,000 minutes is led around the elongated goods in a helical line, and the elongated goods are enveloped by the tape in the axial direction.
